(19) United States
(12) Patent Application Publication
(10) Pub. No.: US 2026/0169522 A1
(43) Pub. Date: Jun. 18, 2026

(54) ANTENNA STRUCTURE AND ELECTRONIC DEVICE INCLUDING SAME

(71) Applicant: Samsung Electronics Co., Ltd., Suwon-si (KR)

(72) Inventors: Namwoo KIM, Suwon-si (KR); Jeongho KANG, Suwon-si (KR); Minho KIM, Suwon-si (KR); Sunglak KIM, Suwon-si (KR); Changi PARK, Suwon-si (KR); Jaeuk AHN, Suwon-si (KR); Yeonggyu YOON, Suwon-si (KR); Jinwook CHOI, Suwon-si (KR); Hyunchul HONG, Suwon-si (KR); Byounguk YOON, Suwon-si (KR)

(21) Appl. No.: 19/538,229

(22) Filed: Feb. 12, 2026

Related U.S. Application Data
(63) Continuation of application No. PCT/KR2024/010303, filed on Jul. 17, 2024.

(30) Foreign Application Priority Data
Aug. 14, 2023 (KR) 10-2023-0106196
Sep. 22, 2023 (KR) 10-2023-0127204

(51) Int. Cl. G06F 1/16

(52) U.S. Cl. CPC G06F 1/1616

(57) ABSTRACT

An electronic device is provided. The electronic device includes a multi-foldable housing including: a second housing; a first housing having a first side, the first housing including a first antenna radiator disposed on the first side and rotatably coupled to one side of the second housing; a third housing having a second side, the third housing including a second antenna radiator disposed on the second side and rotatably coupled to the other side of the second housing; an out-folding hinge disposed between the second housing and the first housing; and an in-folding hinge disposed between the second housing and the third housing. The electronic device further includes a flexible display disposed on a front surface of each of the first housing, the second housing, and the third housing, at least one circuit board disposed inside the multi-foldable housing, and a communication module mounted on the at least one circuit board and electrically connected to the first antenna radiator and the second antenna radiator, wherein, when the multi-foldable housing is in a folded state, at least a portion of the flexible display that is located on the out-folding hinge is visually exposed to an outside of the electronic device and is spaced apart from the second antenna radiator.

### CROSS-REFERENCE TO RELATED APPLICATIONS

This application is a continuation of International Application No. PCT/KR2024/010303, filed on Jul. 17, 2024, which is based on and claims priority to Korean Patent Application 10-2023-0106196 filed on Aug. 14, 2023, and Korean Patent Application No. 10-2023-0127204 filed on Sep. 22, 2023, in the Korean Intellectual Property Office, the disclosures of which are incorporated by reference herein in their entireties.

### BACKGROUND

### Technical Field

Various embodiments of the disclosure relate to an electronic device, e.g., an antenna structure and an electronic device including the same.

### Background Art

With the remarkable advancement of information and communication technology and semiconductor technology, the distribution and use of various electronic devices are rapidly increasing. In particular, recent electronic devices are being developed to be portable and capable of communication.

An electronic device may refer to a device that performs a specific function according to a mounted program, such as home appliances, electronic organizers, portable multimedia players, mobile communication terminals, tablet personal computers (PCs), video/audio devices, desktop/laptop computers, or vehicle navigation systems. For example, such electronic devices may output stored information as sound or video. As the integration density of electronic devices increases and ultra-high-speed, high-capacity wireless communication becomes common, recently, various functions may be mounted on a single electronic device such as a mobile communication terminal. For example, not only a communication function but also an entertainment function such as a game, a multimedia function such as music/video playback, a communication and security function for mobile banking, and a schedule management or electronic wallet function are being integrated into a single electronic device. These electronic devices have been downsized to be conveniently carried by users.

As mobile communication services extend up to multimedia service sectors, the display of the electronic device may be increased to allow the user satisfactory use of multimedia services as well as voice call or text messaging services. Accordingly, a foldable flexible display may be disposed on the entire area of the housing structure separated to be foldable.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, e.g., an antenna structure and an electronic device including the same.

Additional aspects will be set forth in part in the description which follows and, in part, will be apparent from the description, or may be learned by practice of the presented embodiments.

An electronic device is provided. The electronic device includes a multi-foldable housing including: a second housing; a first housing having a first side, the first housing including a first antenna radiator disposed on the first side and rotatably coupled to one side of the second housing; a third housing having a second side, the third housing including a second antenna radiator disposed on the second side and rotatably coupled to the other side of the second housing; an out-folding hinge disposed between the second housing and the first housing; and an in-folding hinge disposed between the second housing and the third housing. The electronic device further includes a flexible display disposed on a front surface of each of the first housing, the second housing, and the third housing, at least one circuit board disposed inside the multi-foldable housing, and a communication module mounted on the at least one circuit board and electrically connected to the first antenna radiator and the second antenna radiator, wherein, when the multi-foldable housing is in a folded state, at least a portion of the flexible display that is located on the out-folding hinge is visually exposed to an outside of the electronic device and is spaced apart from the second antenna radiator.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a front view illustrating an unfolded state of an electronic device according to an embodiment of the disclosure;

FIG. 2B is a rear view illustrating an unfolded state of an electronic device according to an embodiment of the disclosure;

FIG. 3A is a perspective view illustrating a folded state of an electronic device according to an embodiment of the disclosure;

FIG. 3B is a front view illustrating a folded state of an electronic device according to an embodiment of the disclosure;

FIG. 3C is a rear view illustrating a folded state of an electronic device according to an embodiment of the disclosure;

FIG. 3D is a side view illustrating a folded state of an electronic device according to an embodiment of the disclosure;

FIG. 3E is a side view illustrating a folded state of an electronic device, as viewed from an opposite direction to FIG. 3D according to an embodiment of the disclosure;

FIG. 3F is a top view illustrating a folded state of an electronic device according to an embodiment of the disclosure;

FIG. 3G is a bottom view illustrating a folded state of an electronic device according to an embodiment of the disclosure;

FIG. 4 is an exploded perspective view illustrating an electronic device according to an embodiment of the disclosure;

FIG. 5 is an exploded perspective view illustrating the electronic device, as viewed from a different direction from FIG. 4 according to an embodiment of the disclosure;

FIG. 6A is a conceptual view illustrating an antenna structure of a first housing according to an embodiment of the disclosure;

FIG. 6B is a conceptual view illustrating an antenna structure of a third housing according to an embodiment of the disclosure;

FIG. 7A is a cross-sectional view taken along line A-A′ of FIG. 3D according to an embodiment of the disclosure;

FIG. 7B is a cross-sectional perspective view taken along line A-A′ of FIG. 3D according to an embodiment of the disclosure;

FIG. 8 is a schematic diagram illustrating a first folding area and a 3-2th side surface according to an embodiment of the disclosure;

FIG. 9A is a cross-sectional view taken along line A-A′ of FIG. 3D according to an embodiment of the disclosure;

FIG. 9B is a cross-sectional view taken along line A-A′ of FIG. 3D according to an embodiment of the disclosure;

FIG. 9C is a cross-sectional view taken along line A-A′ of FIG. 3D according to an embodiment of the disclosure;

FIG. 10 is a cross-sectional view taken along line B-B′ of FIG. 3E according to an embodiment of the disclosure;

FIG. 11A is a cross-sectional view taken along line B-B′ of FIG. 3E according to an embodiment of the disclosure;

FIG. 11B is a cross-sectional view taken along line B-B′ of FIG. 3E according to an embodiment of the disclosure;

FIG. 11C is a cross-sectional view taken along line B-B′ of FIG. 3E according to an embodiment of the disclosure;

FIG. 12A is a perspective view illustrating an electronic device according to an embodiment of the disclosure;

FIG. 12B is a cross-sectional view taken along line C-C′ of FIG. 3F according to an embodiment of the disclosure;

FIG. 13 is a front view illustrating an unfolded state of an electronic device according to an embodiment of the disclosure; and

FIG. 14 is a front view illustrating the unfolded state of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

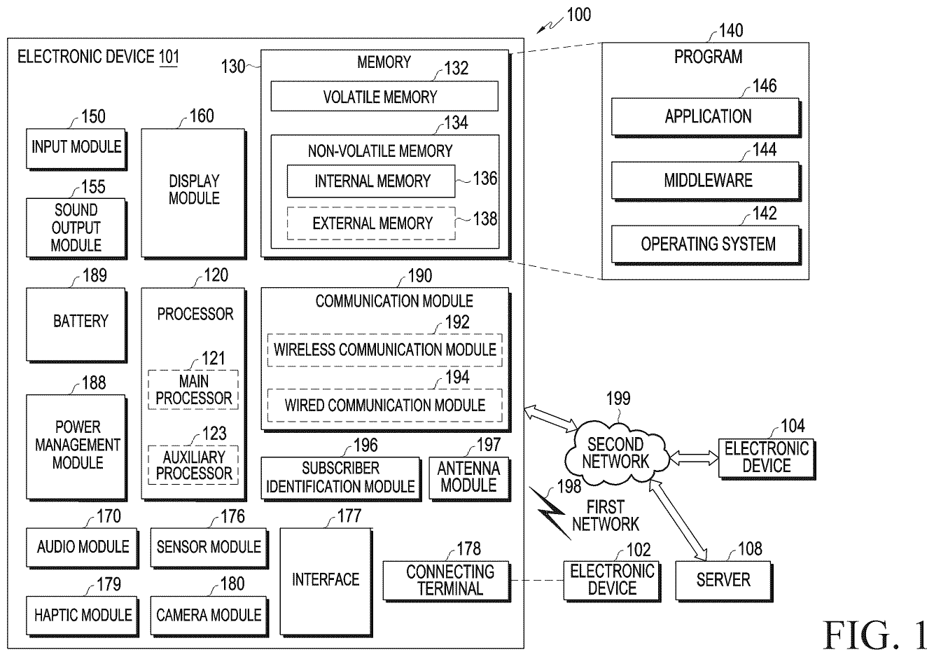

FIG. 1 is a block diagram illustrating an electronic device 101 in a network environment 100, according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

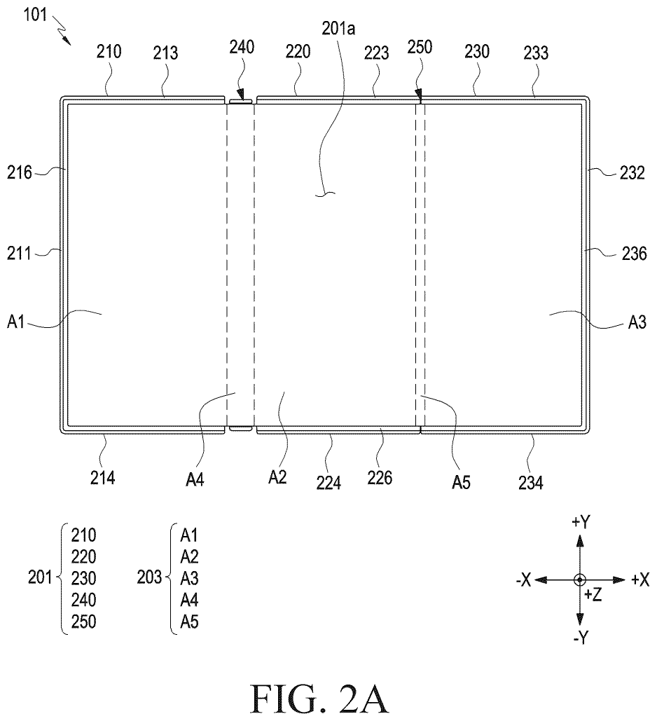

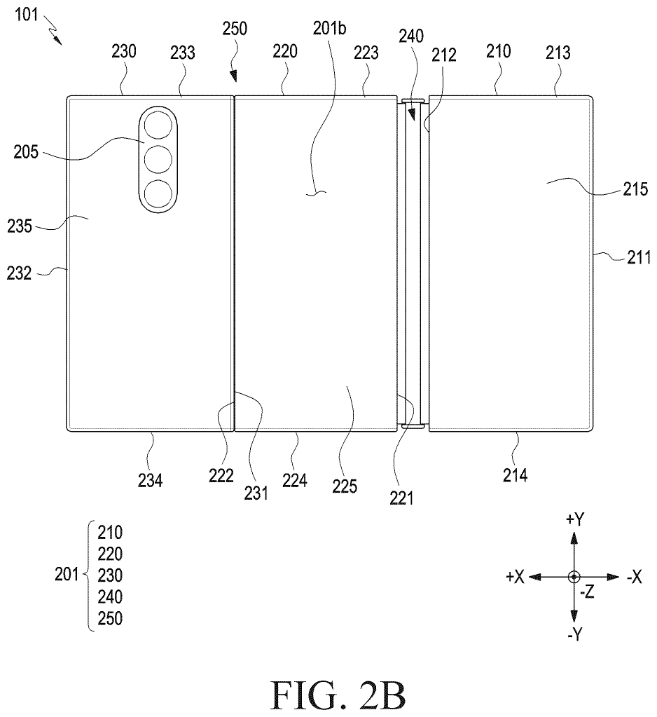

FIG. 2A is a front view illustrating an unfolded state of an electronic device according to an embodiment of the disclosure.

FIG. 2B is a rear view illustrating an unfolded state of an electronic device according to an embodiment of the disclosure.

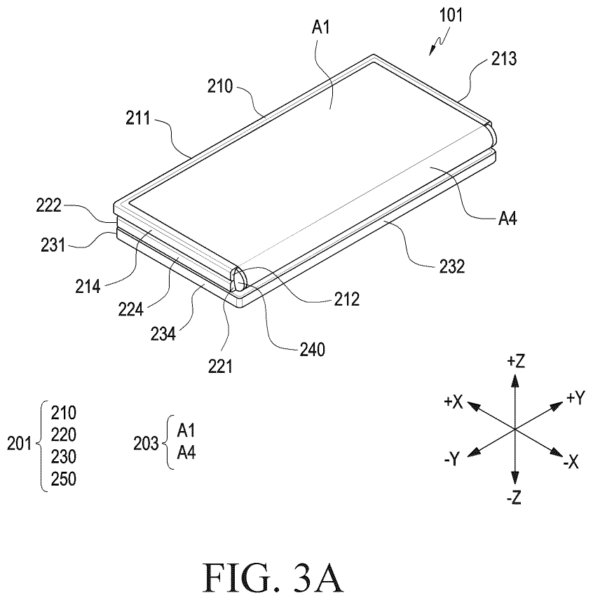

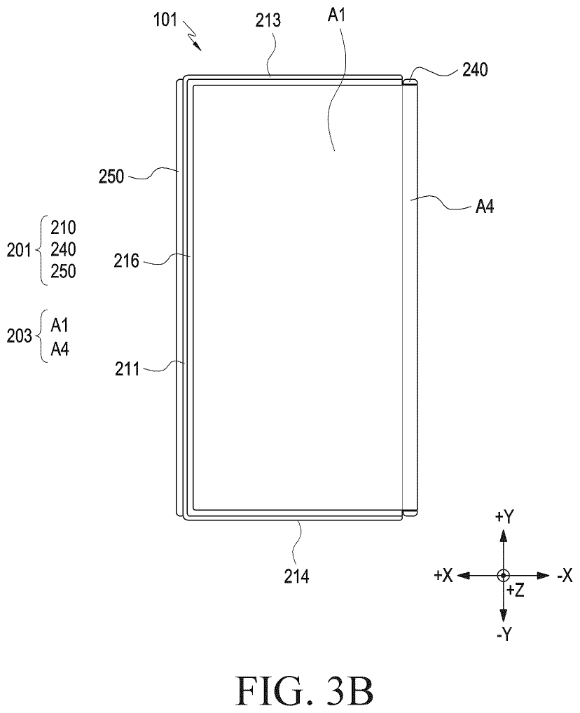

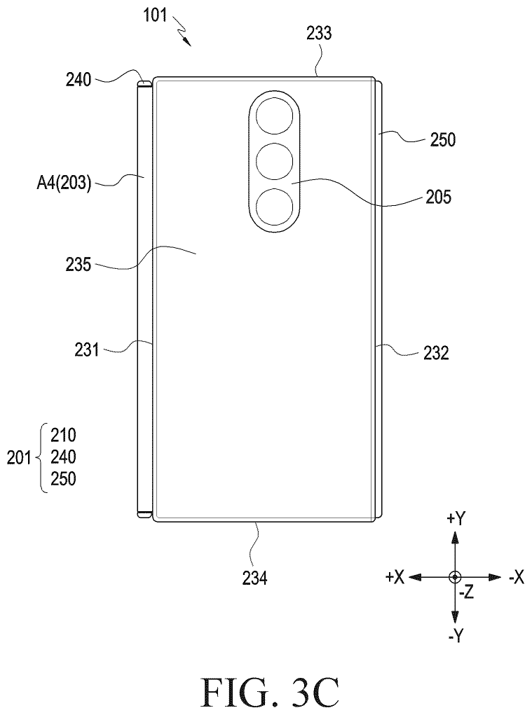

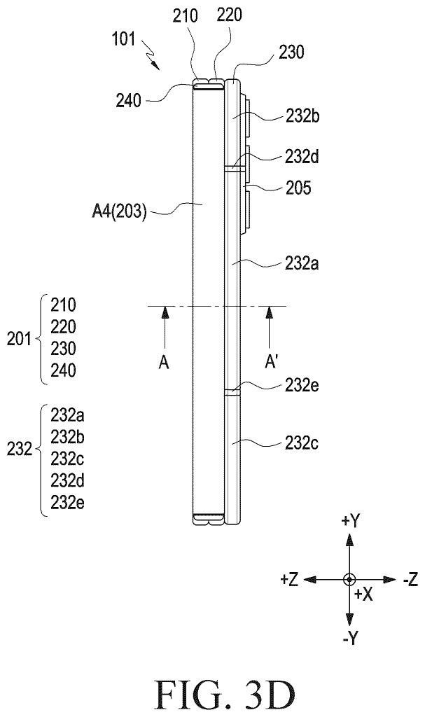

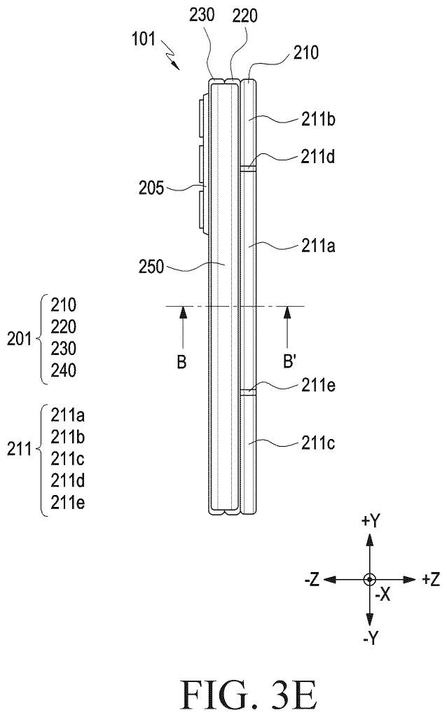

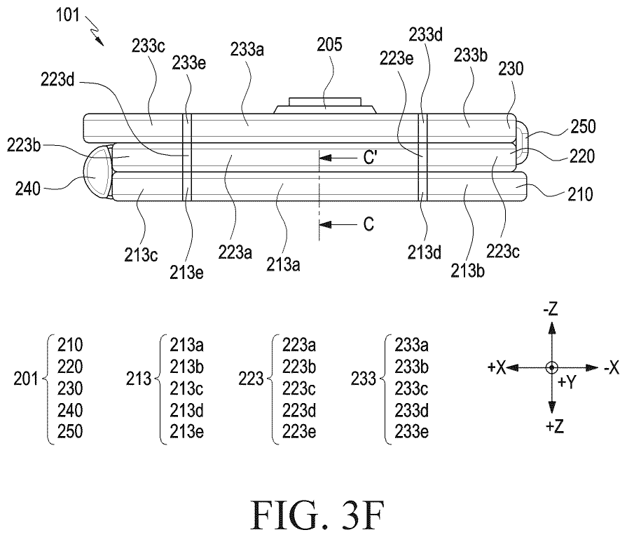

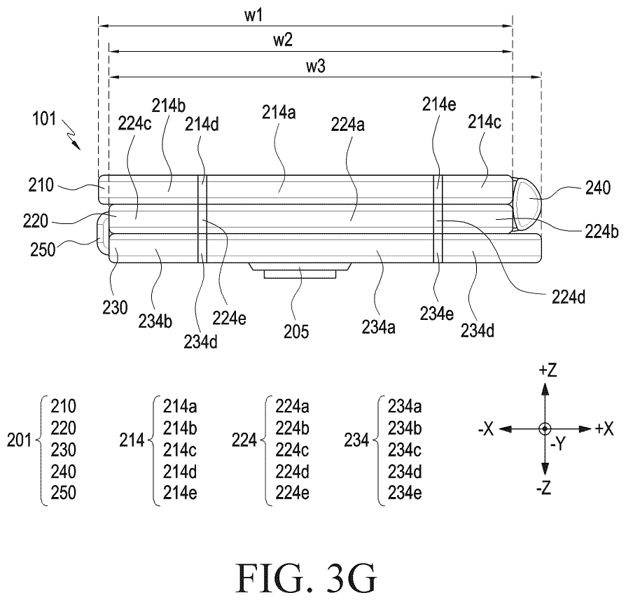

FIG. 3A is a perspective view illustrating a folded state of an electronic device according to an embodiment of the disclosure.

FIG. 3B is a front view illustrating a folded state of an electronic device according to an embodiment of the disclosure.

FIG. 3C is a rear view illustrating a folded state of an electronic device according to an embodiment of the disclosure.

FIG. 3D is a side view illustrating a folded state of an electronic device according to an embodiment of the disclosure.

FIG. 3E is a side view illustrating a folded state of an electronic device, as viewed from an opposite direction to FIG. 3D according to an embodiment of the disclosure.

FIG. 3F is a top view illustrating a folded state of an electronic device according to an embodiment of the disclosure.

FIG. 3G is a bottom view illustrating a folded state of an electronic device according to an embodiment of the disclosure.

FIGS. 2A and 2B are views illustrating an unfolded state of an electronic device 101 (or a foldable electronic device 101) according to an embodiment of the disclosure. FIGS. 3A to 3G are views illustrating a folded state of the electronic device 101 (or the foldable electronic device 101) according to an embodiment of the disclosure. The electronic device 101 of FIGS. 2A, 2B, and 3A to 3G may be an example of the electronic device 101 illustrated in FIG. 1 and may be a foldable or bendable electronic device 101.

Hereinafter, for convenience of description, a spatial coordinate system (or a Cartesian coordinate system) including an X axis, a Y axis, or a Z axis is illustrated in FIGS. 2A, 2B, and 3A to 3G, 4, 5, 6A, 6B, 7A, 7B, 8, 9A to 9C, 10, 11A to 11C, 12A, 12B, 13, and 14. The X-axis direction, Y-axis direction, or Z-axis direction is defined or described with respect to the first housing 210, but is not limited thereto. In describing an embodiment of the disclosure, the ‘first direction and/or the second direction’ may mean directions parallel to the Z-axis direction.

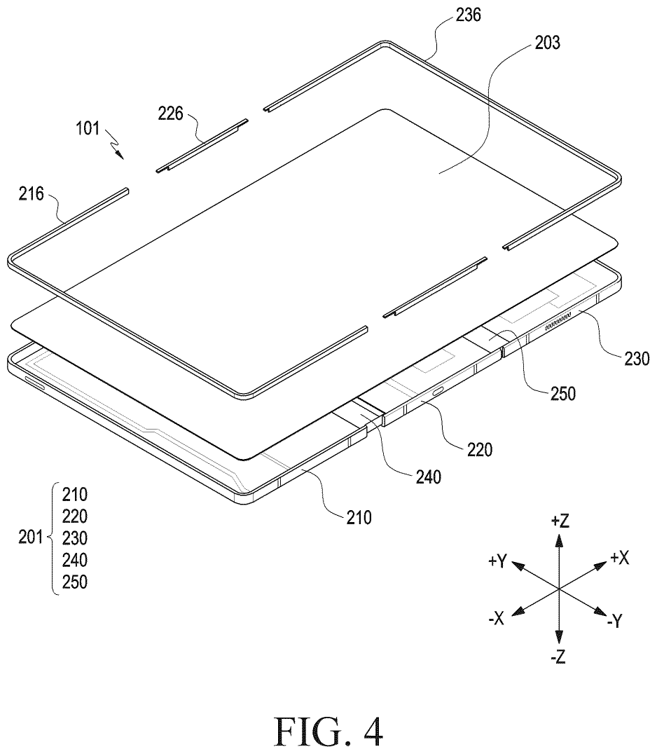

The embodiments of FIGS. 2A, 2B, and 3A to 3G may be combined with the embodiment of FIG. 1 or the embodiments of FIGS. 4, 5, 6A, 6B, 7A, 7B, 8, 9A to 9C, 10, 11A to 11C, 12A, 12B, 13, and 14.

The configuration of the electronic device 101 of FIGS. 2A, 2B, and 3A to 3G may be identical in whole or part to the configuration of the electronic device 101 of FIG. 1.

Referring to FIGS. 2A, 2B, and 3A to 3G, an electronic device 101 may include a housing 201 or a flexible or foldable display (hereinafter, simply “flexible display 203”) (e.g., the display module 160 of FIG. 1) disposed in a space formed by the housing 201.

According to an embodiment, the housing 201 may be defined and/or referred to as a foldable housing 201, a multi-foldable housing 201, or a deformable housing 201.

According to an embodiment, in the state in which the electronic device 101 is unfolded (e.g., FIGS. 2A and 2B), the surface on which the flexible display 203 is disposed (or the surface where the flexible display 203 is viewed from the outside of the electronic device 101) may be defined as a front surface 201a of the electronic device 101. In the unfolded state of the electronic device 101, the opposite surface of the front surface 201a may be defined as a rear surface 201b of the electronic device 101. The surface surrounding the space between the front and rear surfaces may be defined as a side surface of the electronic device 101.

According to an embodiment, the housing 201 may include a first housing 210, a second housing 220, a third housing 230, a first hinge structure 240, or a second hinge structure 250. The first hinge structure 240 may be defined and/or referred to as a first hinge assembly. The second hinge structure 250 may be defined and/or referred to as a second hinge assembly.

According to an embodiment, the first hinge structure 240 may be connected to the first housing 210 or the second housing 220. The second housing 220 may be rotatably connected to the first housing 210 through the first hinge structure 240. According to an embodiment, the second hinge structure 250 may be connected to the second housing 220 or the third housing 230. The third housing 230 may be rotatably connected to the second housing 220 through the second hinge structure 250.

According to an embodiment, the electronic device 101 may include a sensor area. The sensor area may be disposed on the housing 201. In the sensor area, an illuminance sensor and an image sensor may be disposed. The illuminance sensor may detect the amount of light around the electronic device 101, and the image sensor may convert light incident through the camera lens into a digital signal. The illuminance sensor and the image sensor may be visually exposed to the flexible display 203. According to an embodiment, the illuminance sensor and the image sensor may not be visually exposed. For example, the camera may be configured as an under display camera (UDC). The pixels in one area of the flexible display 203 corresponding to the position of the UDC are configured differently from pixels in the other areas, so that the image sensor and/or camera may not be visually exposed.

According to an embodiment, the first housing 210 may be connected to the first hinge structure 240. The first housing 210 may include a first front surface facing a first direction (e.g., the +Z direction of FIG. 2A) or a first rear surface facing a second direction (e.g., the −Z direction of FIG. 2B) opposite to the first direction. The second housing 220 may be connected to the first hinge structure 240. The second housing 220 may include a second front surface facing the first direction (e.g., the +Z direction of FIG. 2A), or a second rear surface facing the second direction (e.g., the −Z direction of FIG. 2B) opposite to the first direction.

According to an embodiment, the first housing 210 may rotate with respect to the second housing 220 about the first hinge structure 240. The first housing 210 and the second housing 220 may be provided in a folded state (e.g., FIGS. 3A to 3G) or an unfolded state (e.g., FIGS. 2A and 2B). When the first housing 210 and the second housing 220 are in the folded state, the first rear surface of the first housing 210 may face the second rear surface of the second housing 220. When the first housing 210 and the second housing 220 are in the folded state, the first front surface of the first housing 210 may face the direction opposite to the second front surface of the second housing 220. When the first housing 210 and the second housing 220 are in the unfolded state, the first front surface of the first housing 210 may face the same direction as the second front surface of the second housing 220. When the first housing 210 and the second housing 220 are in the unfolded state, the first rear surface of the first housing 210 may face the same direction as the second rear surface of the second housing 220.

According to an embodiment, the second housing 220 may be connected to the second hinge structure 250. The third housing 230 may be connected to the second hinge structure 250. The third housing 230 may include a third front surface facing the first direction (e.g., the +Z direction of FIG. 2A), or a third rear surface facing the second direction (e.g., the −Z direction of FIG. 2B) opposite to the first direction.

According to an embodiment, the second housing 220 may rotate with respect to the third housing 230 around the second hinge structure 250. The second housing 220 and the third housing 230 may be provided in a folded state (e.g., FIGS. 3A to 3G) or an unfolded state (e.g., FIGS. 2A and 2B). When the second housing 220 and the third housing 230 are in the folded state, the second front surface of the second housing 220 may face the third front surface of the third housing 230. When the second housing 220 and the third housing 230 are in the folded state, the second rear surface of the second housing 220 may face the direction opposite to the third rear surface of the third housing 230. When the second housing 220 and the third housing 230 are in the unfolded state, the second front surface of the second housing 220 may face the same direction as the third front surface of the third housing 230. When the second housing 220 and the third housing 230 are in the unfolded state, the second rear surface of the second housing 220 may face the same direction as the third rear surface of the third housing 230.

According to an embodiment, the first housing 210 may include a 1-1th side surface 211, a 1-2th side surface 212, a 1-3th side surface 213, or a 1-4th side surface 214. The side surfaces of the first housing 210 may be defined and/or referred to as edge portions, side walls, and side portions of the first housing 210. The side surfaces of the first housing 210 may form at least a portion of the exterior of the first housing 210 between the first front surface and the first rear surface. The 1-1th side surface 211 of the first housing 210 may be referred to as a first side surface 211 of the first housing 210.

According to an embodiment, the second housing 220 may include a 2-1th side surface 221, a 2-2th side surface 222, a 2-3th side surface 223, or a 2-4th side surface 224. The side surfaces of the second housing 220 may be defined and/or referred to as edge portions, side walls, and side portions of the second housing 220. The side surfaces of the second housing 220 may form at least a portion of the exterior of the second housing 220 between the second front surface and the second rear surface. The 2-1th side surface 221 of the second housing 220 may be referred to as one side surface 221 of the second housing 220. The 2-2th side surface 222 of the second housing 220 may be referred to as another side surface 222 of the second housing 220.

According to an embodiment, the third housing 230 may include a 3-1th side surface 231, a 3-2th side surface 232, a 3-3th side surface 233, or a 3-4th side surface 234. The side surfaces of the third housing 230 may be defined and/or referred to as edge portions, side walls, and side portions of the third housing 230. The side surfaces of the third housing 230 may form at least a portion of the exterior of the third housing 230 between the third front surface and the third rear surface. The 3-2th side surface 232 of the third housing 230 may be referred to as a second side surface 232 of the third housing 230.

According to an embodiment, the 1-1th side surface 211 of the first housing 210 may be disposed between the first front surface and the first rear surface to be spaced apart from the folding axis of the first hinge structure 240. The 1-1th side surface 211 may be disposed to be spaced apart from the 1-2th side surface 212 in a parallel state. The 1-3th side surface 213 may connect an upper end of the 1-1th side surface 211 to an upper end of the 1-2th side surface 212. The 1-3th side surface 213 may be defined and/or referred to as an upper side surface of the first housing 210. The 1-4th side surface 214 may connect a lower end of the 1-1th side surface 211 to a lower end of the 1-2th side surface 212. The 1-4th side surface 214 may be defined and/or referred to as a lower side surface of the first housing 210. The 1-4th side surfaces 214 may be disposed to be spaced apart from the 1-3th side surfaces 213 in a parallel state. The 1-3th side surface 213 and/or the 1-4th side surface 214 may be disposed substantially perpendicular to the 1-1th side surface 211 and/or the 1-2th side surface 212. The 1-2th side surface 212 may be connected to the 2-1th side surface 221 through the first hinge structure 240.

According to an embodiment, the 2-1th side surface 221 of the second housing 220 may be disposed between the second front surface and the second rear surface to be spaced apart from the folding axis of the second hinge structure 250 in a parallel state. The 2-1th side surface 221 may be disposed to be spaced apart from the 2-2th side surface 222 in a parallel state. The 2-3th side surface 223 may connect an upper end of the 2-1th side surface 221 and an upper end of the 2-2th side surface 222. The 2-3th side surface 223 may be defined and/or referred to as an upper side surface of the second housing 220. The 2-4th side surface 224 may connect a lower end of the 2-1th side surface 221 to a lower end of the 2-2th side surface 222. The 2-4th side surface 224 may be defined and/or referred to as a lower side surface of the second housing 220. The 2-4th side surfaces 224 may be disposed to be spaced apart from the 2-3th side surfaces 223 in a parallel state. The 2-3th side surface 223 and/or the 2-4th side surface 224 may be disposed substantially perpendicular to the 2-1th side surface 221 and/or the 2-2th side surface 222. The 2-1th side surface 221 may be connected to the 1-2th side surface 212 through the first hinge structure 240. The 2-2th side surface 222 may be connected to the 3-1th side surface 231 through the second hinge structure 250.

According to an embodiment, the 3-1th side surface 231 of the third housing 230 may be disposed between the third front surface and the third rear surface to be spaced apart from the folding axis of the second hinge structure 250 in a parallel state. The 3-1th side surface 231 may be disposed to be spaced apart from the 3-2th side surface 232 in a parallel state. The 3-3th side surface 233 may connect an upper end of the 3-1th side surface 231 and an upper end of the 3-2th side surface 232. The 3-3th side surface 233 may be defined and/or referred to as an upper side surface of the third housing 230. The 3-4th side surface 234 may connect a lower end of the 3-1th side surface 231 to a lower end of the 3-2th side surface 232. The 3-4th side surface 234 may be defined and/or referred to as a lower side surface of the third housing 230. The 3-4th side surfaces 234 may be disposed to be spaced apart from the 3-3th side surfaces 233 in a parallel state. The 3-3th side surface 233 and/or the 3-4th side surface 234 may be disposed substantially perpendicular to the 3-1th side surface 231 and/or the 3-2th side surface 232. The 3-1th side surface 231 may be connected to the 2-2th side surface 222 through the second hinge structure 250.

According to an embodiment, when the first housing 210 is folded with respect to the second housing 220 around the first hinge structure 240 (e.g., FIGS. 3A to 3G), the 1-1th side surface 211 may approach the 2-2th side surface 222. When the first housing 210 is unfolded with respect to the second housing 220 about the first hinge structure 240 (e.g., FIGS. 2A and 2B), the 1-1-th side surface 211 may move away from the 2-2-th side surface 222.

According to an embodiment, when the second housing 220 is folded with respect to the third housing 230 around the second hinge structure 250 (e.g., FIGS. 3A and 3G), the 2-1th side surface 221 may approach the 3-2th side surface 232. When the second housing 220 is unfolded with respect to the third housing 230 around the second hinge structure 250 (e.g., FIGS. 2A and 2B), the 2-1th side surface 221 may move away from the 3-2th side surface 232.

According to an embodiment, when the first housing 210 and the second housing 220 are in a fully folded state, a first rear surface and a second rear surface may face each other, and a distance between a 1-1th side surface 211 and a 2-2th side surface 222 may be formed to be the closest. According to an embodiment, the first housing 210 and the second housing 220 are disposed on two opposite sides of the first hinge structure 240 and may have a shape that is generally symmetrical with respect to the first hinge structure 240. As is described below, the angle or distance between the first housing 210 and the second housing 220 may vary depending on whether the state of the first housing 210 and the second housing 220 is the unfolded state, the folded state, or an intermediate state, i.e., a partially unfolded (or partially folded).

According to an embodiment, when the second housing 220 and the third housing 230 are in a fully folded state, a second front surface and a third front surface may face each other, and a distance between a 2-1th side surface 221 and a 3-2th side surface 232 may be formed to be the closest. According to an embodiment, the second housing 220 and the third housing 230 are disposed on two opposite sides of the second hinge structure 250, and may have a shape that is generally symmetrical with respect to the second hinge structure 250. As is described below, the angle or distance between the second housing 220 and the third housing 230 may vary depending on whether the state of the second housing 220 and the third housing 230 is the unfolded state, the folded state, or an intermediate state, i.e., a partially unfolded (or partially folded.

According to an embodiment, referring to FIG. 2A, the first housing 210, the second housing 220, and the third housing 230 together may form a recess for receiving the flexible display 203. According to an embodiment, at least a portion of the first housing 210, the second housing 220, and the third housing 230 may be formed of a metal material or a non-metal material having a rigidity magnitude selected to support the flexible display 203. At least a portion formed of metal may provide a ground plane of the electronic device 101 and may be electrically connected with a ground line formed on the printed circuit board disposed in the foldable housing 201.

According to an embodiment, protecting members 216, 226, 236 may be disposed outside the flexible display 203. The protecting members may be integrally formed with the side surfaces of the foldable housing 201 or may be formed as separate structures. The flexible display 203 may not be adhered to the side surface of the foldable housing 201 and/or the protecting member. A gap may be formed between the flexible display 203 and the protecting member. The protecting member may be configured to cover the internal configuration of the electronic device 101 from the outside or to protect the internal configuration of the electronic device 101 from external impact. According to an embodiment, the protecting member may be configured to cover wirings disposed on the flexible display 203 from the outside or to protect the wirings from an external impact. The protecting member may be defined and/or referred to as a deco member, a peripheral member, or a rim member. The protecting member may be formed of, but is not limited to, a non-metal member.

According to an embodiment, the protecting member 216, 226, 236 may include a first protecting member 216 disposed on the first housing 210, a second protecting member 226 disposed on the second housing 220, or a third protecting member 236 disposed on the third housing 230. The first protecting member 216 may be defined as a partial configuration of the first housing 210. The second protecting member 226 may be defined as a partial configuration of the second housing 220. The third protecting member 236 may be defined as a partial configuration of the third housing 230.

According to an embodiment, the first housing 210 may include a first rear cover 215. The first rear cover 215 may be disposed on one side of the first hinge structure 240 on the rear surface 201b of the electronic device 101, and may have, e.g., a substantially rectangular edge. The edge of the first rear cover 215 may be surrounded by side surfaces of the first housing 210.

According to an embodiment, the second housing 220 may include a second rear cover 225. The second rear cover 225 may be disposed on the other side of the first hinge structure 240 or one side of the second hinge structure 250 on the rear surface 201b of the electronic device 101, and may have, e.g., a substantially rectangular edge. The edge of the second rear cover 225 may be surrounded by side surfaces of the second housing 220.

According to an embodiment, the third housing 230 may include a third rear cover 235. The third rear cover 235 may be disposed on the other side of the second hinge structure 250 on the rear surface 201b of the electronic device 101, and may have, e.g., a substantially rectangular edge. The edge of the third rear cover 235 may be surrounded by side surfaces of the third housing 230.

According to an embodiment, the first rear cover 215 and the second rear cover 225 may have a substantially symmetrical shape with respect to the first hinge structure 240. The second rear cover 225 and the third rear cover 235 may have a substantially symmetrical shape with respect to the second hinge structure 250. However, the first rear cover 215, the second rear cover 225, and the third rear cover 235 do not necessarily have a mutually symmetrical shape, and in an embodiment, the electronic device 101 may include a first rear cover 215, a second rear cover 225, and a third rear cover 235 having various shapes. In an embodiment, the first rear cover 215 may be integrally formed with the first housing 210, the second rear cover 225 may be integrally formed with the second housing 220, and the third rear cover 235 may be integrally formed with the third housing 230.

According to an embodiment, the first rear cover 215, the second rear cover 225, the third rear cover 235, the first housing 210, the second housing 220, and the third housing 230 may form a space in which various components (e.g., a printed circuit board or a battery) of the electronic device 101 may be disposed. According to an embodiment, one or more components may be disposed or visually exposed on the rear surface 201b of the electronic device 101. One or more components or sensors may be visually exposed through the third rear cover 235. In an embodiment, the sensor may include a proximity sensor.

According to an embodiment, the front camera disposed on the front surface of the electronic device 101 (e.g., the camera disposed on the first housing 210 and exposed through the first display area A1) or the rear camera 205 exposed through the third rear cover 235 may include one or more lenses, image sensors, and/or image signal processor. The flash may include, e.g., a light emitting diode or a xenon lamp. In an embodiment, two or more lenses (infrared cameras, wide-angle and telephoto lenses) and image sensors may be disposed on one surface of the electronic device 101.

According to an embodiment, the first hinge structure 240 or the second hinge structure 250 may be covered or exposed to the outside, by a portion of the first housing 210, the second housing 220, or the third housing 230 according to the state (unfolded state, intermediate state, or folded state) of the electronic device 101.

According to an embodiment, referring to FIGS. 2A and 2B, when the electronic device 101 is in an unfolded state (e.g., a fully unfolded state), at least a portion of the first hinge structure 240 may be exposed to the outside between the first housing 210 and the second housing 220, and the second hinge structure 250 may be concealed by the second housing 220 and the third housing 230 and may not be exposed.

According to an embodiment, referring to FIGS. 3A to 3G, when the electronic device 101 is in a folded state (e.g., a fully folded state), the first hinge structure 240 may be concealed by the first housing 210 and the second housing 220 and may not be exposed to the outside, and the second hinge structure 250 may be exposed to the outside between the second housing 220 and the third housing 230. According to an embodiment, when the electronic device 101 is in the folded state, at least a portion of the first hinge structure 240 may be at least partially exposed to the outside of the first housing 210 and the second housing 220.

According to an embodiment, when the first housing 210 and the second housing 220 are in a first intermediate state in which a predetermined angle is formed therebetween, the first hinge structure 240 may be partially exposed to the outside between the first housing 210 and the second housing 220. However, in this case, the exposed area may be smaller than in the state in which the first housing 210 and the second housing 220 are fully unfolded. In an embodiment, the first hinge structure 240 may include a curved surface.

According to an embodiment, when the second housing 220 and the third housing 230 are in a second intermediate state in which a predetermined angle is formed therebetween, the second hinge structure 250 may be partially exposed to the outside between the second housing 220 and the third housing 230. However, in this case, the exposed area may be smaller than in the state in which the second housing 220 and the third housing 230 are fully folded. According to an embodiment, the second hinge structure 250 may include a curved surface.

According to an embodiment, the flexible display 203 may be disposed in a space formed by the housing 201. For example, the flexible display 203 is seated in a recess formed by the housing 201 and may be seen from the outside through the front surface 201a (e.g., the first front surface, the second front surface, and/or the third front surface) of the electronic device 101. According to an embodiment, the flexible display 203 may constitute most of the front surface 201a (e.g., the first front surface, the second front surface, and/or the third front surface) of the electronic device 101. Accordingly, the front surface 210a (e.g., the first front surface, the second front surface, and/or the third front surface) of the electronic device 101 may include the flexible display 203, a partial area of the first housing 210 adjacent to the flexible display 203, a partial area of the second housing 220 adjacent to the flexible display 203, and a partial area of the third housing 230 adjacent to the flexible display 203 The rear surface 201b (e.g., first rear surface, second rear surface and/or third rear surface) of the electronic device 101 may include the first rear cover 215, a partial area of the first housing 210 adjacent to the first rear cover 215, the second rear cover 225, a partial area of the second housing 220 adjacent to the second rear cover 225, the third rear cover 235, and a partial area of the third housing 230 adjacent to the third rear cover 235.

According to an embodiment, the flexible display 203 may be disposed on the front surface of each of the first housing 210, the second housing 220, and the third housing 230.

According to an embodiment, the flexible display 203 may mean a display in which at least a partial area of the flexible display 203 may be transformed into a flat or curved surface. For example, flexible display 203 may be configured to be at least partially folded or at least partially unfolded.

According to an embodiment, the flexible display 203 may include a first display area A1, a second display area A2, a third display area A3, a first folding area A4, or a second folding area A5. The first display area A1 may be disposed on one side of the first folding area A4, and the second display area A2 may be disposed on the other side of the first folding area A4. The second display area A2 may be disposed on one side of the second folding area A5, and the third display area A3 may be disposed on the other side of the second folding area A5.

According to an embodiment, the first display area A1 may be disposed on the first housing 210, the second display area A2 may be disposed on the second housing 220, and the third display area A3 may be disposed on the third housing 230. According to an embodiment, the first folding area A4 may connect the first display area A1 and the second display area A2, and may be disposed on the first hinge structure 240. The second folding area A5 may connect the second display area A2 and the third display area A3, and may be disposed on the second hinge structure 250. The area division of the flexible display 203 shown in FIGS. 2A and 2B is exemplary, and the display may be divided into a plurality of areas (e.g., six or more or three areas) according to the structure or function.

According to an embodiment, the flexible display 203 may be coupled or disposed adjacent to a touch panel provided with a touch sensing circuit and a pressure sensor capable of measuring the intensity (pressure) of the touch. For example, the flexible display 203 is an example of a touch panel and may be coupled or disposed adjacent to an electromagnetic induction panel that detects an electromagnetic resonance (EMR) type stylus pen.

According to an embodiment, the first display area A1 and the second display area A2 may have an overall symmetrical shape with respect to the first folding area A4. The second display area A2 and the third display area A3 may have an overall symmetrical shape with respect to the second folding area A5.

Hereinafter, the operation of the first housing 210 and the second housing 220 and the operation of each area of the flexible display 203 according to the states (e.g., the folded state, the unfolded state, or the first intermediate state) of the first housing 210 and the second housing 220 are described.

According to an embodiment, when the first housing 210 and the second housing 220 are in the unfolded state (e.g., FIGS. 2A and 2B), the first front surface of the first housing 210 and the second front surface of the second housing 220 may be disposed to form an angle of 180 degrees and face the same direction. The surface of the first display area A1 and the surface of the second display area A2 of the flexible display 203 form 180 degrees therebetween, and may face the same direction (e.g., the forward direction of the electronic device 101). In this case, the first folding area A4 may form the same plane as the first display area A1 and the second display area A2.

According to an embodiment, when a state of the first housing 210 and the second housing 220 is a folded state (e.g., FIGS. 3A to 3G), the first rear surface of the first housing 210 and the second rear surface of the second housing 220 may be disposed to face each other. For example, a first rear cover 215 and a second rear cover 225 may be disposed to face each other. A surface of the first display area A1 of the flexible display 203 and a surface of the second display area A2 may face opposite directions. For example, when the state of the first housing 210 and the second housing 220 is the folded state, the first display area A1 may be disposed to face a +Z direction, and the second display area A2 may be disposed to face a −Z direction opposite to the +Z direction. For example, when the state of the first housing 210 and the second housing 220 is the folded state and the state of the second housing 220 and the third housing 230 is the folded state, the surface of the first display area A1 may face the outside of the electronic device 101, and the surface of the second display area A2 may face the surface of the third display area A3. When the first housing 210 and the second housing 220 are in the folded state, at least a portion of the first folding area A4 may form a curved surface having a predetermined curvature. The curved surface of the first folding area A4 may be disposed to face the outside of the electronic device 101.

According to an embodiment, when the first housing 210 and the second housing 220 are in the first intermediate state, the first housing 210 and the second housing 220 may be disposed at a predetermined angle therebetween. The surface of the first display area A1 of the flexible display 203 and the surface of the second display area A2 may form an angle greater than the unfolded state and smaller than the folded state. At least a portion of the first folding area A4 may form a curved surface having a designated curvature, and the curvature in this case may be smaller than that in the folded state. For example, the radius of curvature of the curved surface of the first folding area A4 in the first intermediate state may be larger than the radius of curvature of the curved surface of the first folding area A4 in the folded state.

Hereinafter, the operation of the second housing 220 and the third housing 230 and the operation of each area of the flexible display 203 according to the state (e.g., the folded state, the unfolded state, or the second intermediate state) of the second housing 220 and the third housing 230 are described.

According to an embodiment, when the second housing 220 and the third housing 230 are in the unfolded state (e.g., FIGS. 2A and 2B), the second front surface of the second housing 220 and the third front surface of the third housing 230 may be disposed to form an angle of 180 degrees and face the same direction. The surface of the second display area A2 and the surface of the third display area A3 of the flexible display 203 form 180 degrees therebetween, and may face the same direction (e.g., the forward direction of the electronic device 101). In this case, the second folding area A5 may form the same plane as the second display area A2 and the third display area A3.

According to an embodiment, when a state of the second housing 220 and the third housing 230 is a folded state (e.g., FIGS. 3A to 3G), the second rear surface of the second housing 220 and the third rear surface of the third housing 230 may face opposite directions. For example, the second rear cover 225 may be disposed to face the +Z direction, and a third rear cover 235 may be disposed to face the −Z direction. For example, when the state of the second housing 220 and the third housing 230 is the folded state and the state of the first housing 210 and the second housing 220 is the folded state, the second rear cover 225 may face the first rear cover 215, and the third rear cover 235 may face the outside of the electronic device 101. When the state of the second housing 220 and the third housing 230 is the folded state, the surface of the second display area A2 of the flexible display 203 and the surface of the third display area A3 may be disposed to face each other. When the second housing 220 and the third housing 230 are in the folded state, at least a portion of the second folding area A5 may form a curved surface having a predetermined curvature. The curved surface of the second folding area A5 may be disposed to face the inside of the electronic device 101.

According to an embodiment, when the second housing 220 and the third housing 230 are in the second intermediate state, the second housing 220 and the third housing 230 may be disposed at a predetermined angle therebetween. The surface of the second display area A2 of the flexible display 203 and the surface of the third display area A3 may form an angle smaller than in the unfolded state and larger than in the folded state. At least a portion of the second folding area A5 may form a curved surface having a designated curvature, and the curvature in this case may be smaller than that in the folded state. For example, the radius of curvature of the curved surface of the second folding area A5 in the second intermediate state may be larger than the radius of curvature of the curved surface of the second folding area A5 in the folded state.

According to an embodiment, the fully folded state of the electronic device 101 may be defined as a state in which the first housing 210 and the second housing 220 are in the folded state while the second housing 220 and the third housing 230 are in the folded state. The fully unfolded state of the electronic device 101 may be defined as a state in which the second housing 220 and the third housing 230 are in the unfolded state while the second housing 220 and the third housing 230 are in the unfolded state.

According to an embodiment, when the state of the electronic device 101 is a fully folded state (e.g., FIGS. 3A to 3G), the first folding area A4 located on the first hinge structure 240 may be exposed to the outside of the electronic device 101. For example, when the state of the electronic device 101 is the fully folded state (e.g., FIGS. 3A to 3G), the first folding area A4 located on the first hinge structure 240 may be visually exposed to the outside of the electronic device 101. The second folding area A5 positioned on the second hinge structure 250 may be disposed inside the electronic device 101 and may not be exposed to the outside. In an embodiment, the first hinge structure 240 may be defined and/or referred to as an out-folding hinge 240 that exposes a portion of the flexible display 203 to the outside of the electronic device 101 in the folded state, and the second hinge structure 250 may be defined and/or referred to as an in-folding hinge 250 that does not expose a portion of the flexible display 203 to the outside in the folded state. In an embodiment, the first hinge structure 240 may be provided as an in-folding hinge, and the second hinge structure 250 may be provided as an out-folding hinge.

According to an embodiment, the fully unfolded state (e.g., FIGS. 2A and 2B) of the electronic device 101 may be defined and/or referred to as a first state of the electronic device 101, and the fully folded state (e.g., FIGS. 3A to 3G) of the electronic device 101 may be defined and/or referred to as a second state of the electronic device 101.

According to an embodiment, the first hinge structure 240 may rotatably connect the first housing 210 and the second housing 220 to each other. The first hinge structure 240 may be connected to the 1-2th side surface 212 of the first housing 210 and the 2-1th side surface 221 of the second housing 220.

According to an embodiment, the second hinge structure 250 may rotatably connect the second housing 220 and the third housing 230 to each other. The second hinge structure 250 may be connected to the 2-2th side surface 222 of the second housing 220 and the 3-1th side surface 231 of the third housing 230.

According to an embodiment, when the state of the electronic device 101 is the fully folded state (e.g., FIGS. 3A to 3G), a rear camera 205 may face opposite to the surface of the first display area A1. The rear camera 205 may face the outside of the electronic device 101 when the state of the electronic device 101 is the fully folded state (e.g., FIGS. 3A to 3G), or when the state of the electronic device 101 is the fully unfolded state (e.g., FIGS. 2A and 2B).

According to an embodiment, the first housing 210 may include a first conductive portion formed of a metallic material and a first non-conductive portion formed of a non-metallic material. The first conductive portion may be defined and/or referred to as a first metallic portion. The first non-conductive portion may be defined and/or referred to as a first non-metallic portion, or a first segmentation portion.

According to an embodiment, the first conductive portion of the first housing 210 may form at least a portion of side surfaces of the first housing 210, and the first non-conductive portion of the first housing 210 may form the rest of the side surfaces of the first housing 210.

According to an embodiment, the first conductive portion of the first housing 210 may include a 1-1th conductive portion 211a, a 1-2th conductive portion 211b, a 1-3th conductive portion 211c, a 1-4th conductive portion 213a, a 1-5th conductive portion 213b, a 1-6th conductive portion 213c, a 1-7th conductive portion 214a, a 1-8th conductive portion 214b, or a 1-9th conductive portion 214c.

According to an embodiment, the first non-conductive portion of the first housing 210 may include a 1-1th non-conductive portion 211d, a 1-2th non-conductive portion 211e, a 1-3th non-conductive portion 213d, a 1-4th non-conductive portion 213e, a 1-5th non-conductive portion 214d, or a 1-6th non-conductive portion 214e.

According to an embodiment, the 1-1th side surface 211 of the first housing 210 may include the 1-1th conductive portion 211a, the 1-2th conductive portion 211b, the 1-3th conductive portion 211c, the 1-1th non-conductive portion 211d, or the 1-2th non-conductive portion 211e. The 1-1th conductive portion 211a may be disposed between the 1-2th conductive portion 211b and the 1-3th conductive portion 211c. The 1-1th conductive portion 211a may be separated from the 1-2th conductive portion 211b by the 1-1th non-conductive portion 211d and may not be electrically connected to the 1-2th conductive portion 211b. The 1-1th conductive portion 211a may be separated from the 1-3th conductive portion 211c by the 1-2th non-conductive portion 211e and may not be electrically connected to the 1-3th conductive portion 211c. The 1-2th conductive portion 211b may be disposed perpendicular to the 1-5th conductive portion 213b and may be connected to the 1-5th conductive portion 213b. The 1-3th conductive portion 211c may be disposed perpendicular to the 1-8th conductive portion 214b and may be connected to the 1-8th conductive portion 214b.

According to an embodiment, the 1-3th side surface 213 of the first housing 210 may include the 1-4th conductive portion 213a, the 1-5th conductive portion 213b, the 1-6th conductive portion 213c, the 1-3th non-conductive portion 213d, or the 1-4th non-conductive portion 213e. The 1-4th conductive portion 213a may be disposed between the 1-5th conductive portion 213b and the 1-6th conductive portion 213c. The 1-4th conductive portion 213a may be separated from the 1-5th conductive portion 213b by the 1-3th non-conductive portion 213d and may not be electrically connected to the 1-5th conductive portion 213b. The 1-4th conductive portion 213a may be separated from the 1-6th conductive portion 213c by the 1-4th non-conductive portion 213e and may not be electrically connected to the 1-6th conductive portion 213c. The 1-5th conductive portion 213b may be disposed perpendicular to the 1-2th conductive portion 211b and may be connected to the 1-2th conductive portion 211b. The 1-6th conductive portion 213c may be disposed perpendicular to the 1-2th side surface 212 and may be connected to the 1-2th side surface 212.

According to an embodiment, the 1-4th side surface 214 of the first housing 210 may include the 1-7th conductive portion 214a, the 1-8th conductive portion 214b, the 1-9th conductive portion 214c, the 1-5th non-conductive portion 214d, or the 1-6th non-conductive portion 214e. The 1-7th conductive portion 214a may be disposed between the 1-8th conductive portion 214b and the 1-9th conductive portion 214c. The 1-7th conductive portion 214a may be separated from the 1-8th conductive portion 214b by the 1-5th non-conductive portion 214d and may not be electrically connected to the 1-8th conductive portion 214b. The 1-7th conductive portion 214a may be separated from the 1-9th conductive portion 214c by the 1-6th non-conductive portion 214e and may not be electrically connected to the 1-9th conductive portion 214c. The 1-8th conductive portion 214b may be disposed perpendicular to the 1-3th conductive portion 211c and may be connected to the 1-3th conductive portion 211c. The 1-9th conductive portion 214c may be disposed perpendicular to the 1-2th side surface 212 and may be connected to the 1-2th side surface 212.

According to an embodiment, the second housing 220 may include a second conductive portion formed of a metallic material and a second non-conductive portion formed of a non-metallic material. The second conductive portion may be defined and/or referred to as a second metallic portion. The second non-conductive portion may be defined and/or referred to as a second non-metallic portion, or a second segmentation portion.

According to an embodiment, the second conductive portion of the second housing 220 may form at least a portion of side surfaces of the second housing 220, and the second non-conductive portion of the second housing 220 may form the rest of the side surfaces of the second housing 220.

According to an embodiment, the second conductive portion of the second housing 220 may include a 2-1th conductive portion 223a, a 2-2th conductive portion 223b, a 2-3th conductive portion 223c, a 2-4th conductive portion 224a, a 2-5th conductive portion 224b, or a 2-6th conductive portion 224c.

According to an embodiment, the second non-conductive portion of the second housing 220 may include a 2-1th non-conductive portion 223d, a 2-2th non-conductive portion 223e, a 2-3th non-conductive portion 224d, or a 2-4th non-conductive portion 224e.

According to an embodiment, the 2-1th side surface 221 may include a conductive portion, or a non-conductive portion. The 2-2th side surface 222 may include a conductive portion, or a non-conductive portion.

According to an embodiment, the 2-3th side surface 223 of the second housing 220 may include the 2-1th conductive portion 223a, the 2-2th conductive portion 223b, the 2-3th conductive portion 223c, the 2-1th non-conductive portion 223d, or the 2-2th non-conductive portion 223e. The 2-1th conductive portion 223a may be disposed between the 2-2th conductive portion 223b and the 2-3th conductive portion 223c. The 2-1th conductive portion 223a may be separated from the 2-2th conductive portion 223b by the 2-1th non-conductive portion 223d and may not be electrically connected to the 2-2th conductive portion 223b. The 2-1th conductive portion 223a may be separated from the 2-3th conductive portion 223c by the 2-2th non-conductive portion 223e and may not be electrically connected to the 2-3th conductive portion 223c. The 2-2th conductive portion 223b may be disposed perpendicular to the 2-1th side surface 221 and may be connected to the 2-1th side surface 221. The 2-3th conductive portion 223c may be disposed perpendicular to the 2-2th side surface 222 and may be connected to the 2-2th side surface 222.

According to an embodiment, the 2-4th side surface 224 of the second housing 220 may include the 2-4th conductive portion 224a, the 2-5th conductive portion 224b, the 2-6th conductive portion 224c, the 2-3th non-conductive portion 224d, or the 2-4th non-conductive portion 224e. The 2-4th conductive portion 224a may be disposed between the 2-5th conductive portion 224b and the 2-6th conductive portion 224c. The 2-4th conductive portion 224a may be separated from the 2-5th conductive portion 224b by the 2-3th non-conductive portion 224d and may not be electrically connected to the 2-5th conductive portion 224b. The 2-4th conductive portion 224a may be separated from the 2-6th conductive portion 224c by the 2-4th non-conductive portion 224e and may not be electrically connected to the 2-6th conductive portion 224c. The 2-5th conductive portion 224b may be disposed perpendicular to the 2-1th side surface 221 and may be connected to the 2-1th side surface 221. The 2-6th conductive portion 224c may be disposed perpendicular to the 2-2th side surface 222 and may be connected to the 2-2th side surface 222.

According to an embodiment, the third housing 230 may include a third conductive portion formed of a metallic material and a third non-conductive portion formed of a non-metallic material. The third conductive portion may be defined and/or referred to as a third metallic portion. The third non-conductive portion may be defined and/or referred to as a third non-metallic portion, or a third segmentation portion.

According to an embodiment, the third conductive portion of the third housing 230 may form at least a portion of side surfaces of the third housing 230, and the third non-conductive portion of the third housing 230 may form the rest of the side surfaces of the third housing 230.

According to an embodiment, the third conductive portion of the third housing 230 may include a 3-1th conductive portion 232a, a 3-2th conductive portion 232b, a 3-3th conductive portion 232c, a 3-4th conductive portion 233a, a 3-5th conductive portion 233b, a 3-6th conductive portion 233c, a 3-7th conductive portion 234a, a 3-8th conductive portion 234b, or a 3-9th conductive portion 234c.

According to an embodiment, the third non-conductive portion of the third housing 230 may include a 3-1th non-conductive portion 232d, a 3-2th non-conductive portion 232e, a 3-3th non-conductive portion 233d, a 3-4th non-conductive portion 233e, a 3-5th non-conductive portion 234d, or a 3-6th non-conductive portion 234e.

According to an embodiment, the 3-2th side surface 232 of the third housing 230 may include the 3-1th conductive portion 232a, the 3-2th conductive portion 232b, the 3-3th conductive portion 232c, the 3-1th non-conductive portion 232d, or the 3-2th non-conductive portion 232e. The 3-1th conductive portion 232a may be disposed between the 3-2th conductive portion 232b and the 3-3th conductive portion 232c. The 3-1th conductive portion 232a may be separated from the 3-2th conductive portion 232b by the 3-1th non-conductive portion 232d and may not be electrically connected to the 3-2th conductive portion 232b. The 3-1th conductive portion 232a may be separated from the 3-3th conductive portion 232c by the 3-2th non-conductive portion 232e and may not be electrically connected to the 3-3th conductive portion 232c. The 3-2th conductive portion 232b may be disposed perpendicular to the 3-6th conductive portion 233c and may be connected to the 3-6th conductive portion 233c. The 3-3th conductive portion 232c may be disposed perpendicular to the 3-9th conductive portion 234c and may be connected to the 3-9th conductive portion 234c.

According to an embodiment, the 3-3th side surface 233 of the third housing 230 may include the 3-4th conductive portion 233a, the 3-5th conductive portion 233b, the 3-6th conductive portion 233c, the 3-3th non-conductive portion 233d, or the 3-4th non-conductive portion 233e. The 3-4th conductive portion 233a may be disposed between the 3-5th conductive portion 233b and the 3-6th conductive portion 233c. The 3-4th conductive portion 233a may be separated from the 3-5th conductive portion 233b by the 3-3th non-conductive portion 233d and may not be electrically connected to the 3-5th conductive portion 233b. The 3-4th conductive portion 233a may be separated from the 3-6th conductive portion 233c by the 3-4th non-conductive portion 233e and may not be electrically connected to the 3-6th conductive portion 233c. The 3-5th conductive portion 233b may be disposed perpendicular to the 3-1th side surface 231 and may be connected to the 3-1th side surface 231. The 3-6th conductive portion 233c may be disposed perpendicular to the 3-2th conductive portion 232b and may be connected to the 3-2th conductive portion 232b.

According to an embodiment, the 3-4th side surface 234 of the third housing 230 may include the 3-7th conductive portion 234a, the 3-8th conductive portion 234b, the 3-9th conductive portion 234c, the 3-5th non-conductive portion 234d, or the 3-6th non-conductive portion 234e. The 3-7th conductive portion 234a may be disposed between the 3-8th conductive portion 234b and the 3-9th conductive portion 234c. The 3-7th conductive portion 234a may be separated from the 3-8th conductive portion 234b by the 3-5th non-conductive portion 234d and may not be electrically connected to the 3-8th conductive portion 234b. The 3-7th conductive portion 234a may be separated from the 3-9th conductive portion 234c by the 3-6th non-conductive portion 234e and may not be electrically connected to the 3-9th conductive portion 234c. The 3-8th conductive portion 234b may be disposed perpendicular to the 3-1th side surface 231 and may be connected to the 3-1th side surface 231. The 3-9th conductive portion 234c may be disposed perpendicular to the 3-3th conductive portion 232c and may be connected to the 3-3th conductive portion 232c.

According to an embodiment, when the state of the electronic device 101 is the fully folded state (e.g., FIGS. 3A to 3G), the 1-4th non-conductive portion 213e may be aligned on a straight line with the 2-1th non-conductive portion 223d and the 3-4th non-conductive portion 233e. When the state of the electronic device 101 is the fully folded state, the 1-3th non-conductive portion 213d may be aligned on a straight line with the 2-2th non-conductive portion 223e and the 3-3th non-conductive portion 233d.

According to an embodiment, when the state of the electronic device 101 is the fully folded state (e.g., FIGS. 3A to 3G), the 1-5th non-conductive portion 214d may be aligned on a straight line with the 2-4th non-conductive portion 224e and the 3-5th non-conductive portion 234d. When the state of the electronic device 101 is the fully folded state, the 1-6th non-conductive portion 214e may be aligned on a straight line with the 2-3th non-conductive portion 224d and the 3-6th non-conductive portion 234e.

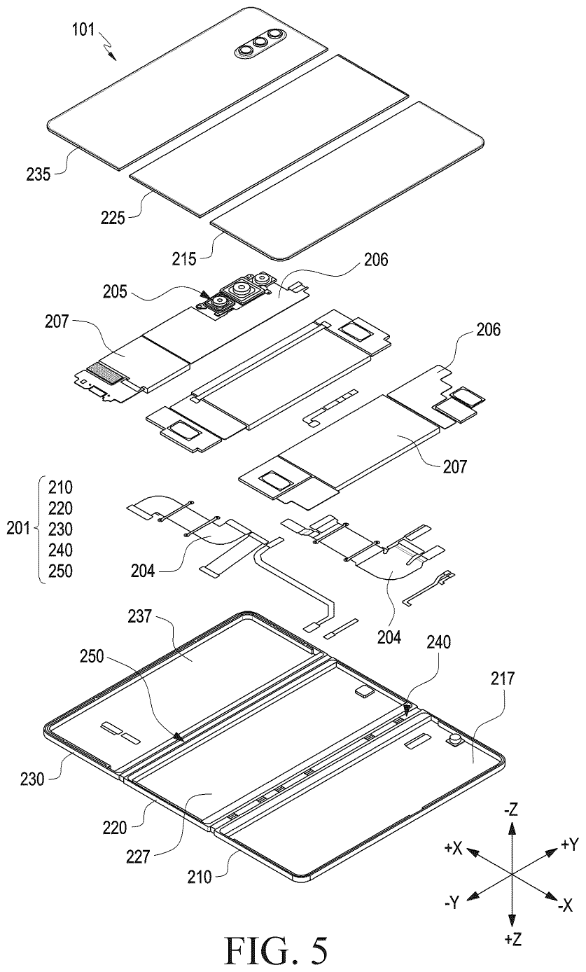

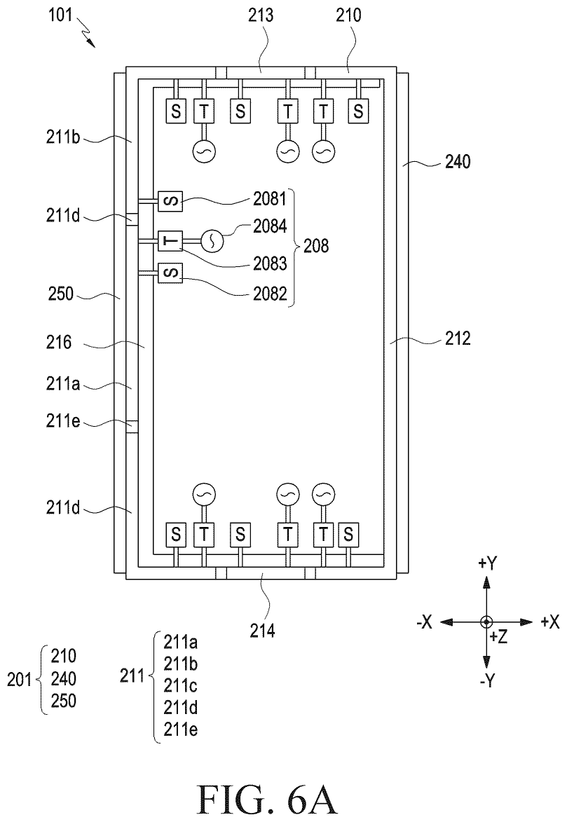

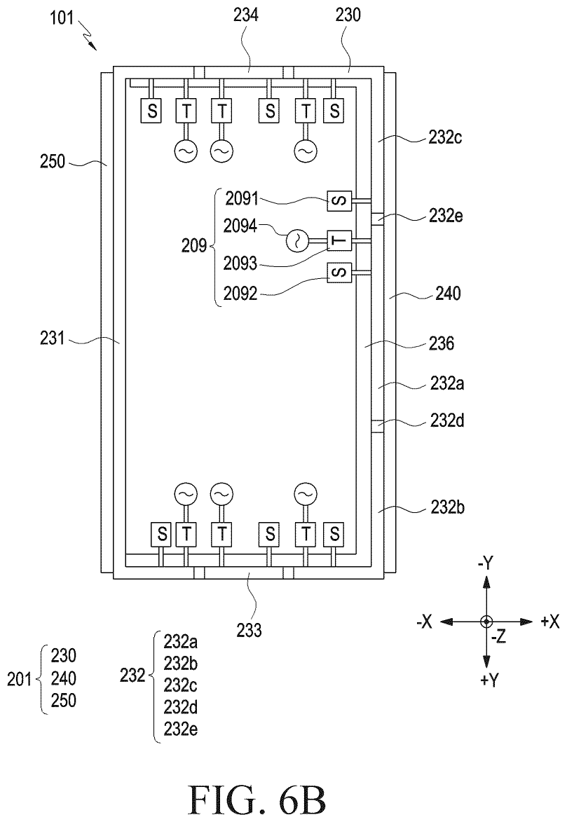

According to an embodiment, the conductive portions of the first housing 210, the second housing 220, and the third housing 230 may be provided as an antenna radiator of the electronic device 101. For example, the conductive portions of the foldable housing 201 may be electrically connected to a communication module (e.g., the communication module 190 of FIG. 1). The electronic device 101 may be configured to transmit/receive a signal to and from an external electronic device 101 (e.g., the electronic device 102, 104 of FIG. 1) through the conductive portions of the foldable housing 201. The communication module (e.g., the communication module 190 of FIG. 1) of the electronic device 101 may be disposed on at least one circuit board (e.g., at least one circuit board 206 of FIG. 5). The communication module (e.g., the communication module 190 of FIG. 1) may be electrically connected to a first antenna radiator (e.g., the first antenna radiator 211a of FIG. 6A). The communication module (e.g., the communication module 190 of FIG. 1) may be electrically connected to a second antenna radiator (e.g., the second antenna radiator 232a of FIG. 6B).

According to an embodiment, based on a width direction (e.g., an X-axis direction of FIG. 3G) of the electronic device 101, the first housing 210 may have a first width w1, the second housing 220 may have a second width w2, and the third housing 230 may have a third width w3. The first width w1 of the first housing 210 may be wider than the second width w2 of the second housing 220. The third width w3 of the third housing 230 may be wider than the second width w2 of the second housing 220. According to an embodiment, the third width w3 of the third housing 230 may be wider than the first width w1 of the first housing 210. According to an embodiment, the first housing 210, the second housing 220, and the third housing 230 may have different widths. According to an embodiment, the first width w1 of the first housing 210 may be substantially the same as the third width w3 of the third housing 230.

FIG. 4 is an exploded perspective view illustrating an electronic device according to an embodiment of the disclosure.

FIG. 5 is an exploded perspective view illustrating the electronic device, as viewed from a different direction from FIG. 4 according to an embodiment of the disclosure.

The embodiment of FIGS. 4 and 5 may be combined with the embodiments of FIGS. 1, 2A, 2B, and 3A to 3G or the embodiments of FIGS. 6A, 6B, 7A, 7B, 8, 9A to 9C, 10, 11A to 11C, 12A, 12B, 13, and 14.

Referring to FIGS. 4 and 5, an electronic device 101 (e.g., the electronic device 101 of FIG. 1, or the electronic device 101 of FIGS. 2A, 2B, and 3A to 3G) may include a foldable housing 201, a flexible display 203, a rear camera 205, at least one conductive connecting member 204, at least one battery 207, or at least one circuit board 206.

The configuration of the foldable housing 201, the flexible display 203, or the rear camera 205 of FIGS. 4 and 5 may be identical in whole or part to the configuration of the foldable housing 201, the flexible display 203, or the rear camera 205 of FIGS. 2A, 2B, and 3A to 3G.

According to an embodiment, the electronic device 101 may include various electronic components (or electrical components) disposed in an inner or outer space of the first housing 210, the second housing 220, and the third housing 230. Various electronic components may include, e.g., a processor (e.g., the processor 120 of FIG. 1), memory (e.g., the memory 130 of FIG. 1), an input module (e.g., the input module 150 of FIG. 1), a sound output module (e.g., the sound output module 155 of FIG. 1), the flexible display 203 (e.g., the display module 160 of FIG. 1), an audio module (e.g., the audio module 170 of FIG. 1), a sensor (e.g., the sensor module 176 of FIG. 1), an interface (e.g., the interface 177 of FIG. 1), a connecting terminal (e.g., the connecting terminal 178 of FIG. 1 or the connecting terminal 289 of FIGS. 2A and 2B), a haptic module (e.g., the haptic module 179 of FIG. 1), a camera module (e.g., the camera module 180 of FIG. 1), a power management module (e.g., the power management module 188 of FIG. 1), the at least one battery 207 (e.g., the battery 189 of FIG. 1), a communication module (e.g., the communication module 190 of FIG. 1), a subscriber identification module (e.g., the subscriber identification module 196 of FIG. 1), or an antenna module (e.g., the antenna module 197 of FIG. 1), and the electronic components may be appropriately distributed and disposed in an internal or external space of the first housing 210, the second housing 220, and the third housing 230. At least one (e.g., the connecting terminal 178) of the components may be omitted from the electronic device 101, or one or more other components may be added in the electronic device 101. Further, some of these components may be integrated into one component.

According to an embodiment, the foldable housing 201 may include a first housing 210 (e.g., the first housing 210 of FIGS. 2A, 2B, and 3A to 3G), a second housing 220 (e.g., the second housing 220 of FIGS. 2A, 2B, and 3A to 3G), a third housing 230 (e.g., the third housing 230 of FIGS. 2A, 2B, and 3A to 3G), a first protecting member 216 (e.g., the first protecting member 216 of FIGS. 2A and 2B), a second protecting member 226 (e.g., the second protecting member 226 of FIGS. 2A and 2B), a third protecting member 236 (e.g., the third protecting member 236 of FIGS. 2A and 2B), a first rear cover 215 (e.g., the first rear cover 215 of FIGS. 2A, 2B, and 3A to 3G), a second rear cover 225 (e.g., the second rear cover 225 of FIGS. 2A, 2B, and 3A to 3G), a third rear cover 235 (e.g., the third rear cover 235 of FIGS. 2A, 2B, and 3A to 3G), a first hinge structure 240 (e.g., the first hinge structure 240 of FIGS. 2A, 2B, and 3A to 3G), or a second hinge structure 250 (e.g., the second hinge structure 250 of FIGS. 2A, 2B, and 3A to 3G).

According to an embodiment, the first housing 210 may include a first plate 217. One surface (e.g., a surface facing the +Z direction of FIG. 5) of the first plate 217 may support the flexible display 203 (e.g., the first display area A1 of FIG. 2A). At least one battery 207, at least one circuit board 206, or electrical/electronic components may be disposed on another surface (e.g., a surface facing the −Z direction of FIG. 5) of the first plate 217. The first plate 217 may be defined and/or referred to as a first bracket, or a first supporting member. The first plate 217 may be connected to the side surfaces of the first housing 210.

According to an embodiment, the second housing 220 may include a second plate 227. One surface (e.g., a surface facing the +Z direction of FIG. 5) of the second plate 227 may support the flexible display 203 (e.g., the second display area A2 of FIG. 2A). At least one battery 207, at least one circuit board 206, or electrical/electronic components may be disposed on another surface (e.g., a surface facing the −Z direction of FIG. 5) of the second plate 227. The second plate 227 may be defined and/or referred to as a second bracket, or a second supporting member. The second plate 227 may be connected to the side surfaces of the second housing 220.

According to an embodiment, the third housing 230 may include a third plate 237. One surface (e.g., a surface facing the +Z direction of FIG. 5) of the third plate 237 may support the flexible display 203 (e.g., the third display area A3 of FIG. 2A). At least one battery 207, at least one circuit board 206, or electrical/electronic components may be disposed on another surface (e.g., a surface facing the −Z direction of FIG. 5) of the third plate 237. The third plate 237 may be defined and/or referred to as a third bracket, or a third supporting member. The third plate 237 may be connected to the side surfaces of the third housing 230.

According to an embodiment, the electronic device 101 may include at least one battery 207 to supply and store power required for driving to the electronic components. At least one battery 207 may be provided as a plurality of batteries respectively disposed in the first housing 210, the second housing 220, and the third housing 230.

According to an embodiment, the first plate 217 and the second plate 227 may be folded or unfolded with respect to each other by a first hinge structure 240 formed corresponding to the first folding area A4 (e.g., the first folding area A4 of FIG. 2A) of the flexible display 203. The second plate 227 and the third plate 237 may be folded or unfolded with respect to each other by a second hinge structure 250 formed corresponding to the second folding area A5 (e.g., the second folding area A5 of FIG. 2A) of the flexible display 203.

According to an embodiment, the flexible display 203 may be disposed in the first housing 210, the second housing 220, and the third housing 230. According to an embodiment, the first display area A1 (e.g., the first display area A1 of FIG. 2A) may be disposed on the first housing 210 (or the first plate 217), the second display area A2 (e.g., the second display area A2 of FIG. 2A) may be disposed on the second housing 220 (or the second plate 227), and the third display area A3 (e.g., the third display area A3 of FIG. 2A) may be disposed on the third housing 230 (or the third plate 237). According to an embodiment, the first folding area A4 (e.g., the first folding area A4 of FIG. 2A) may connect the first display area A1 and the second display area A2, and may be disposed on the first hinge structure 240. The second folding area A5 (e.g., the second folding area A5 of FIG. 2A) may connect the second display area A2 and the third display area A3, and may be disposed on the second hinge structure 250.

According to an embodiment, the electronic device 101 may include at least one circuit board 206. At least one circuit board 206 may include a printed circuit board (PCB), a flexible printed circuit board (FPCB), or a rigid-flexible PCB (RF-PCB). At least one circuit board 206 may be provided as a plurality of circuit boards disposed in the first housing 210, the second housing 220, and the third housing 230. The at least one circuit board 206 may be disposed between the plate 217, 227, 237 and the rear cover 215, 225, 235, but the disclosure is not limited thereto.

According to an embodiment, signals of a processor for implementing various functions and operations of the electronic device 101 may be transmitted to electronic components through various conductive lines and/or connectors formed on at least one circuit board.

According to an embodiment, the flexible display 203 may include a display panel. The flexible display 203 may be at least partially folded or unfolded. The flexible display 203 may be supported by the first plate 217, the second plate 227, and/or the third plate 237.

According to an embodiment, the electronic device 101 may include at least one conductive connection member 204. At least one conductive connection member 204 may be configured to electrically connect a plurality of circuit boards, or to electrically connect at least one circuit board 206 and electrical/electronic components. At least one conductive connection member 204 may include a flexible printed circuit board (FPCB) or a flexible flat cable (FFC). At least a portion of the at least one conductive connection member 204 may be disposed on the first hinge structure 240 or the second hinge structure 250. For example, at least one conductive connection member 204 may be arranged to cross the first hinge structure 240 or the second hinge structure 250.

FIG. 6A is a conceptual view illustrating an antenna structure of a first housing according to an embodiment of the disclosure.

FIG. 6B is a conceptual view illustrating an antenna structure of a third housing according to an embodiment of the disclosure.

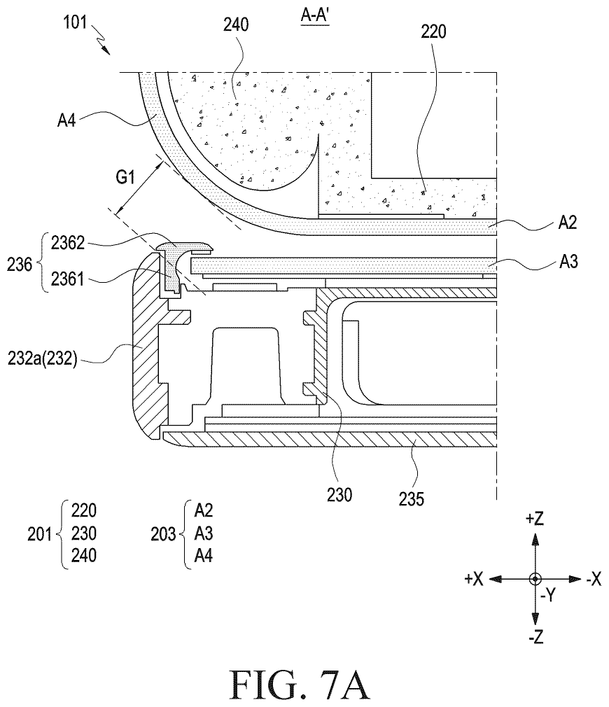

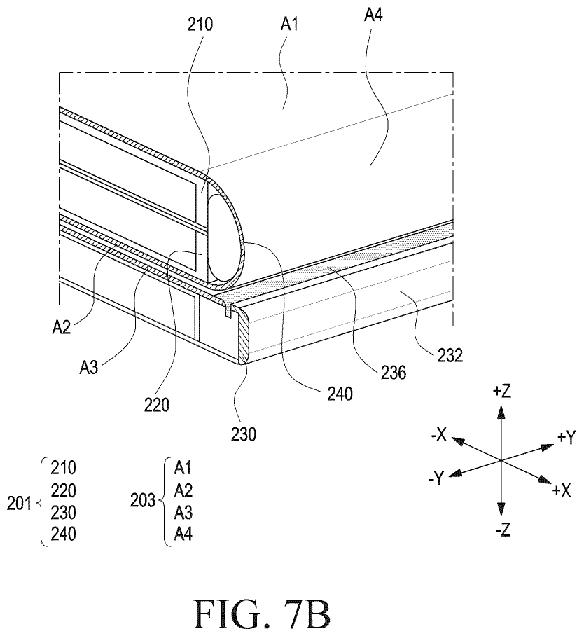

The embodiments of FIGS. 6A and 6B may be combined with the embodiments of FIGS. 1, 2A, 2B, 3A to 3G, 4, and 5, or the embodiments of FIGS. 7A, 7B, 8, 9A to 9C, 10, 11A to 11C, 12A, 12B, 13, and 14.

Referring to FIGS. 6A and 6B, an electronic device 101 (e.g., the electronic device 101 of FIG. 1, or the electronic device 101 of FIGS. 2A, 2B, 3A to 3G, 4, and 5) may include a first housing 210, a third housing 230, a first hinge structure 240, a second hinge structure 250, a first antenna circuit 208, or a second antenna circuit 209.

The configuration of the first housing 210, the third housing 230, the first hinge structure 240, or the second hinge structure 250 of FIGS. 6A and 6B may be identical in whole or part to the configuration of the first housing 210, the third housing 230, the first hinge structure 240, or the second hinge structure 250 of FIGS. 2A, 2B, 3A to 3G, 4, and 5.

According to an embodiment, the electronic device 101 may include an antenna radiator formed of conductive portions of the first housing 210, or an antenna radiator formed of conductive portions of the third housing 230.

According to an embodiment, the first housing 210 may include a 1-1th side surface 211 (e.g., the 1-1th side surface 211 of FIGS. 2A, 2B, and 3A to 3G), a 1-2th side surface 212 (e.g., the 1-2th side surface 212 of FIGS. 2A, 2B, and 3A to 3G), a 1-3th side surface 213 (e.g., the 1-3th side surface 213 of FIGS. 2A, 2B, and 3A to 3G), or a 1-4th side surface 214 (e.g., the 1-4th side surface 214 of FIGS. 2A, 2B, and 3A to 3G).

According to an embodiment, the first housing 210 may include a first antenna structure defined or formed by first conductive portions. The first antenna structure may include a 1-1th conductive portion 211a (e.g., the 1-1th conductive portion 211a of FIGS. 3A to 3G), a 1-2th conductive portion 211b (e.g., the 1-2th conductive portion 211b of FIGS. 3A to 3G), or a 1-3th conductive portion 211c (e.g., the 1-3th conductive portion 211c of FIGS. 3A to 3G). For example, the 1-1th conductive portion 211a may be defined and/or referred to as a 1-1th antenna, the 1-2th conductive portion 211b may be defined and/or referred to as a 1-2th antenna, and the 1-3th conductive portion 211c may be defined and/or referred to as a 1-3th antenna. The 1-1th conductive portion 211a may not be electrically connected to the 1-2th conductive portion 211b by the 1-1th non-conductive portion 211d (e.g., the 1-1th non-conductive portion 211d of FIGS. 3A to 3G), and may not be electrically connected to the 1-3th conductive portion 211c by the 1-2th non-conductive portion 211e (e.g., the 1-2th non-conductive portion 211e of FIGS. 3A to 3G).

Hereinafter, for convenience of description, an antenna radiator defined by the 1-1th conductive portion 211a is described as an example, but the description thereof may be equally or similarly applied or mutatis mutandis to an antenna radiator defined by the 1-2th conductive portion 211b, the 1-3th conductive portion 211c, conductive portions of the 1-3th side surface 213, or conductive portions of the 1-4th side surface 214. The 1-1th conductive portion 211a may be referred to as a first antenna radiator 211a. The first antenna radiator 211a may be defined by a conductive portion disposed between the first non-conductive portion 211d and the second non-conductive portion 211e.

According to an embodiment, the 1-1th conductive portion 211a may be defined and/or referred to as the first antenna radiator 211a. The first antenna radiator 211a may be electrically connected to the first antenna circuit 208. The first antenna circuit 208 may be electrically connected to the communication module (e.g., the communication module 190 of FIG. 1) of the electronic device 101.

According to an embodiment, the first antenna circuit 208 may include a 1-1th switch 2081 and a 1-2th switch 2082. The 1-1th non-conductive portion 211d may be located between the 1-1th switch 2081 and the 1-2th switch 2082. The 1-1th switch 2081 may be connected to the 1-2th conductive portion 211b, and the 1-2th switch 2082 may be connected to the 1-1th conductive portion 211a.

According to an embodiment, according to the operation of the 1-1th switch 2081, the 1-2th conductive portion 211b may be electrically connected to the communication module, or may not be electrically connected to the communication module. Depending on the operation of the 1-2th switch 2082, the 1-1th conductive portion 211a may be electrically connected to the communication module, or may not be electrically connected to the communication module.

According to an embodiment, the first antenna circuit 208 may include a first tuner 2083. The first tuner 2083 may be connected to the 1-1th conductive portion 211a. The first tuner 2083 may include at least one variable capacitor. The first tuner 2083 may be configured to adjust a resonant frequency of the 1-1th conductive portion 211a (or the first antenna radiator 211a) by changing a capacitance of one or more of the at least one variable capacitor based on a control signal provided from the processor (or the communication module).

The first antenna circuit 208 may include a first feeding portion 2084. The first feeding portion 2084 may be electrically connected to the 1-1th conductive portion 211a. The first feeding portion 2084 may provide a feeding signal to the 1-1th conductive portion 211a. The 1-1th conductive portion 211a (e.g., the first antenna radiator 211a) may operate as an antenna based on the feeding signal provided from the first feeding portion 2084.

According to an embodiment, the third housing 230 may include a 3-1th side surface 231 (e.g., the 3-1th side surface 231 of FIGS. 2A, 2B, and 3A to 3G), a 3-2th side surface 232 (e.g., the 3-2th side surface 232 of FIGS. 2A, 2B, and 3A to 3G), a 3-3th side surface 233 (e.g., the 3-3th side surface 233 of FIGS. 2A, 2B, and 3A to 3G), or a 3-4th side surface 234 (e.g., the 3-4th side surface 234 of FIGS. 2A, 2B, and 3A to 3G).

According to an embodiment, the third housing 230 may include a third antenna structure defined or formed by third conductive portions. The third antenna structure may include a 3-1th conductive portion 232a (e.g., the 3-1th conductive portion 232a of FIGS. 3A to 3G), a 3-2th conductive portion 232b (e.g., the 3-2th conductive portion 232b of FIGS. 3A to 3G), or a 3-3th conductive portion 232c (e.g., the 3-3th conductive portion 232c of FIGS. 3A to 3G). For example, the 3-1th conductive portion 232a may be defined and/or referred to as a 3-1th antenna, the 3-2th conductive portion 232b may be defined and/or referred to as a 3-2th antenna, and the 3-3th conductive portion 232c may be defined and/or referred to as a 3-3th antenna. The 3-1th conductive portion 232a may not be electrically connected to the 3-2th conductive portion 232b by the 3-1th non-conductive portion 232d (e.g., the 3-1th non-conductive portion 232d of FIGS. 3A to 3G), and may not be electrically connected to the 3-3th conductive portion 232c by the 3-2th non-conductive portion 232e (e.g., the 3-2th non-conductive portion 232e of FIGS. 3A to 3G).

Hereinafter, for convenience of description, an antenna radiator defined by the 3-1th conductive portion 232a is described as an example, but the description thereof may be equally or similarly applied or mutatis mutandis to an antenna radiator defined by the 3-2th conductive portion 232b, the 3-3th conductive portion 232c, conductive portions of the 3-3th side surface 233, or conductive portions of the 3-4th side surface 234. The 3-1th conductive portion 232a may be referred to as a second antenna radiator 232a. The second antenna radiator 232a may be defined by a conductive portion disposed between the third non-conductive portion 232d and the fourth non-conductive portion 232e.

According to an embodiment, the 3-1th conductive portion 232a may be defined and/or referred to as the second antenna radiator 232a. The second antenna radiator 232a may be electrically connected to the second antenna circuit 209. The second antenna circuit 209 may be electrically connected to the communication module (e.g., the communication module 190 of FIG. 1) of the electronic device 101.

According to an embodiment, the second antenna circuit 209 may include a 2-1th switch 2091 and a 2-2th switch 2092. The 3-2th non-conductive portion 232e may be located between the 2-1th switch 2091 and the 2-2th switch 2092. The 2-1th switch 2091 may be connected to the 3-3th conductive portion 232c, and the 2-2th switch 2092 may be connected to the 3-1th conductive portion 232a.

According to an embodiment, according to the operation of the 2-1th switch 2091, the 3-3th conductive portion 232c may be electrically connected to the communication module, or may not be electrically connected to the communication module. Depending on the operation of the 2-2th switch 2092, the 3-1th conductive portion 232a may be electrically connected to the communication module, or may not be electrically connected to the communication module.

According to an embodiment, the second antenna circuit 209 may include a second tuner 2093. The second tuner 2093 may be connected to the 3-1th conductive portion 232a. The second tuner 2093 may include at least one variable capacitor. The second tuner 2093 may be configured to adjust a resonant frequency of the 3-1th conductive portion 232a (or the second antenna radiator 232a) by changing a capacitance of one or more of the at least one variable capacitor based on a control signal provided from the processor (or the communication module).

The second antenna circuit 209 may include a second feeding portion 2094. The second feeding portion 2094 may be electrically connected to the 3-1th conductive portion 232a. The second feeding portion 2094 may provide a feeding signal to the 3-1th conductive portion 232a. The 3-1th conductive portion 232a (e.g., the second antenna radiator 232a) may operate as an antenna based on the feeding signal provided from the second feeding portion 2094.

FIG. 7A is a cross-sectional view taken along line A-A′ of FIG. 3D according to an embodiment of the disclosure.

FIG. 7B is a cross-sectional perspective view taken along line A-A′ of FIG. 3D according to an embodiment of the disclosure.

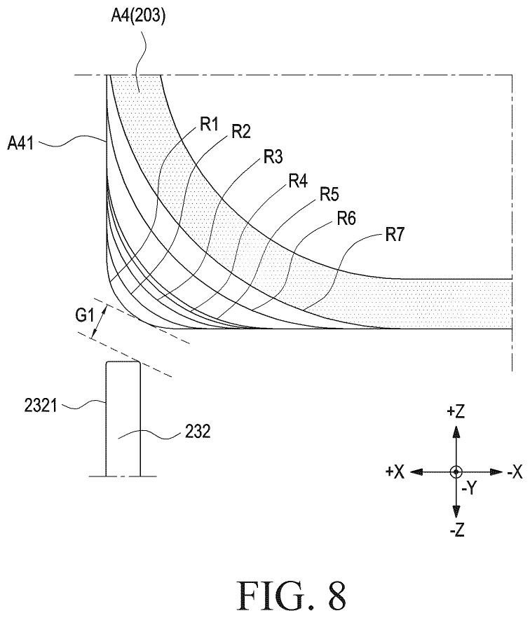

FIG. 8 is a schematic diagram illustrating a first folding area and a 3-2th side surface according to an embodiment of the disclosure.

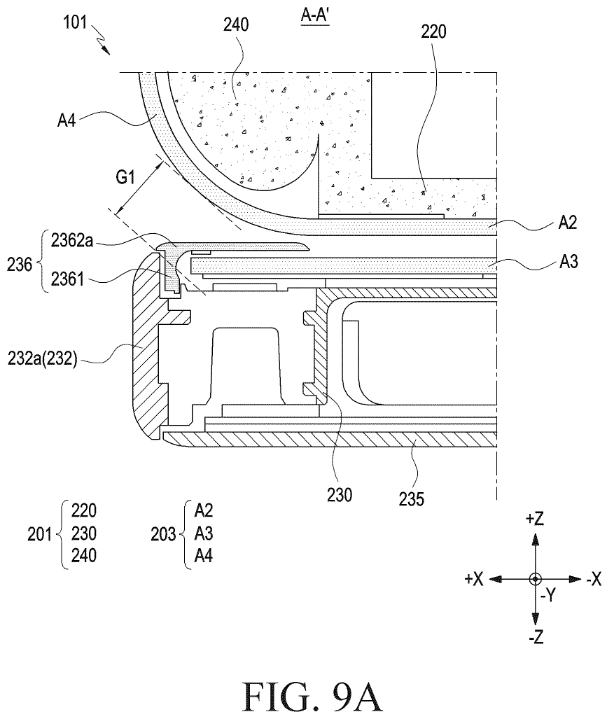

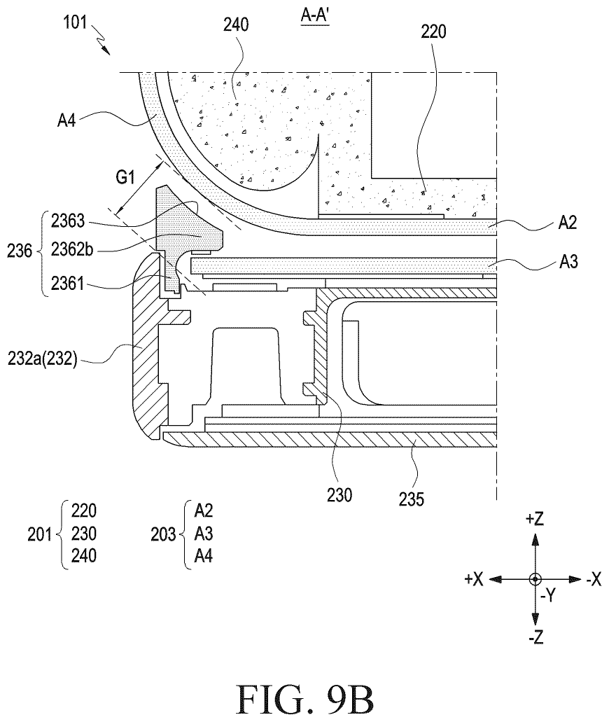

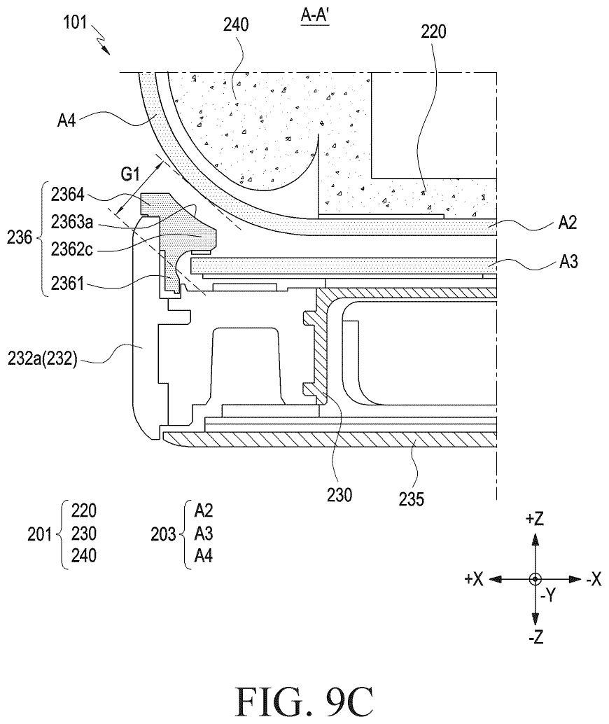

FIG. 9A is a cross-sectional view taken along line A-A′ of FIG. 3D according to an embodiment of the disclosure.

FIG. 9B is a cross-sectional view taken along line A-A′ of FIG. 3D according to an embodiment of the disclosure.

FIG. 9C is a cross-sectional view taken along line A-A′ of FIG. 3D according to an embodiment of the disclosure.

The embodiments of FIGS. 7A, 7B, 8, and 9A to 9C may be combined with the embodiments of FIGS. 1, 2A, 2B, 3A to 3G, 4, 5, 6A, and 6B, or the embodiments of FIGS. 7A, 7B, 8, and 9A to 9C, 10, 11A to 11C, 12A, 12B, 13, and 14.

The embodiments of FIGS. 7A, 7B, 8, and 9A to 9C illustrate a fully folded state of the electronic device 101 (e.g., FIGS. 3A to 3G), or a fully folded state of the second housing 220 and the third housing 230 (e.g., FIGS. 3A to 3G).

Referring to FIGS. 7A, 7B, 8, and 9A to 9C, an electronic device 101 (e.g., the electronic device 101 of FIG. 1, or the electronic device 101 of FIGS. 2A, 2A, 2B, 3A to 3G, 4, 5, 6A, and 6B) may include a foldable housing 201, a second housing 220, a third housing 230, a 2-2th side surface 222, a third rear cover 235, a third protecting member 236, a first hinge structure 240, a flexible display 203, a second display area A2, a third display area A3, or a first folding area A4.

The configuration of the foldable housing 201, the second housing 220, the third housing 230, the 2-2th side surface 222, the third rear cover 235, the third protecting member 236, the first hinge structure 240, the flexible display 203, the first display area A1, the second display area A2, the third display area A3, or the first folding area A4 of FIGS. 7A, 7B, 8, and 9A to 9C may be identical in whole or part to the configuration of the foldable housing 201, the second housing 220, the third housing 230, the 2-2th side surface 222, the third rear cover 235, the third protecting member 236, the first hinge structure 240, the flexible display 203, the first display area A1, the second display area A2, the third display area A3, or the first folding area A4 of FIGS. 2A, 2B, 3A to 3G.

According to an embodiment, when the state of the electronic device 101 is the fully folded state, or when the state of the second housing 220 and the third housing 230 is the fully folded state, the second display area A2 may face the third display area A3. The first folding area A4 disposed on the first hinge structure 240 may form a curved surface having a designated or predetermined curvature. The first folding area A4 disposed on the first hinge structure 240 may be at least partially exposed to the outside of the electronic device 101.

According to an embodiment, among the 3-2th side surface 232 of the third housing 230, the 3-1th conductive portion 232a (e.g., the 3-1th conductive portion 232a of FIGS. 3A to 3G, or the 3-1th conductive portion 232a of FIG. 6B) may be provided as a second antenna radiator 232a (e.g., the second antenna radiator 232a of FIG. 6B).

According to an embodiment, the second antenna radiator 232a may be electrically connected to the communication module (e.g., the communication module 190 of FIG. 1) and may operate as an antenna.

According to an embodiment, when the state of the electronic device 101 is the fully folded state, or when the state of the second housing 220 and the third housing 230 is the fully folded state, the second antenna radiator 232a may be spaced apart from the first folding area A4. For example, a first gap G1 may be formed between the second antenna radiator 232a and the first folding area A4. The first gap G1 may be a minimum distance defined between the second antenna radiator 232a and the first folding area A4. The minimum distance may be defined and/or referred to as a first distance. The first gap G1 may be a separation distance between portions of the second antenna radiator 232a and the first folding area A4 that are disposed closest to each other. For example, the first gap G1 may be a separation distance between the 3-2th side surface 232 and the first folding area A4. For example, a partial area of the second antenna radiator 232a may be spaced apart from a partial area of the first folding area A4 by at least the first gap G1 or more. The first gap G1 may be about 0.9 mm to about 1.1 mm. For example, the first gap G1 may be about 1.0 mm or more. The first gap G1 is not limited thereto, and may have various values according to design changes of the electronic device 101, the foldable housing 201, or the flexible display 203.

According to an embodiment, as a sufficient first gap G1 is secured between the second antenna radiator 232a and the first folding area A4, the electronic device 101 may reduce or limit a phenomenon in which radio waves transmitted and received from the second antenna radiator 232a are lost by the first folding area A4. For example, as a sufficient first gap G1 is secured between the second antenna radiator 232a and the first folding area A4, the electronic device 101 may reduce or limit noise generated from the first folding area A4 from being induced into the second antenna radiator 232a.

Referring to FIG. 8, the first folding area A4 of the flexible display 203 and the 3-2th side surface 232 are illustrated. Table 1 below illustrates a first gap G1 between the 3-2th side surface 232 and the first folding area A4 according to a radius of curvature of the first folding area A4 when an outermost portion A41 of the first folding area A4 and an outermost portion 2321 of the 3-2th side surface 232 are positioned on substantially the same line (e.g., positioned on an imaginary line parallel to the Z axis of FIG. 8). The radius of curvature may be defined as a radius of curvature of a curved surface when the first folding area A4 forms the curved surface in a state in which the second housing 220 and the third housing 230 are in the folded state.

TABLE 1

| | radius of | first gap |
|---|---|---|
| | curvature (mm) | (G1) (mm) |
| R1 | 1.0 | 0.58 |
| R2 | 1.5 | 0.73 |
| R3 | 2.0 | 0.91 |
| R4 | 2.3 | 1.02 |
| R5 | 2.5 | 1.10 |
| R6 | 3.5 | 1.5 |
| R7 | 4.5 | 1.9 |

Referring to FIG. 8 and Table 1, the first gap G1 between the first folding area A4 and the 3-2th side surface 232 may be defined according to the radius of curvature of the first folding area A4. For example, as the radius of curvature of the first folding area A4 increases, the first gap G1 may increase. The numerical values of the radius of curvature and the first gap G1 described in Table 1 above are exemplary, and the radius of curvature of the first folding area A4 and the first gap G1 between the first folding area A4 and the 3-2th side surface 232 may have various values. Referring to FIGS. 7A, 9A, 9B, and 9C, the third protecting member 236 may cover at least a portion of an edge of the third display area A3. The third protecting member 236 may include a non-metallic material.

According to an embodiment, the third protecting member 236 may include a first protecting portion 2361 covering at least a portion of a side surface (e.g., a side surface facing the +X direction of FIGS. 7A, 7B, 8 and 9A to 9C) of the third display area A3. The first protecting portion 2361 may be located between the 3-2th side surface 232 and the third display area A3.

Referring to FIG. 7A, the third protecting member 236 may include a second protecting portion 2362 covering at least a portion of an upper surface (e.g., a surface facing the +Z direction of FIGS. 7A, 7B, 8 and 9A to 9C) of the third display area A3. The second protecting portion 2362 may extend from the first protecting portion 2361.

Referring to FIG. 9A, the third protecting member 236 may include a second protecting portion 2362a covering at least a portion of the upper surface (e.g., the surface facing the +Z direction of FIGS. 7A, 7B, 8 and 9A to 9C) of the third display area A3. The second protecting portion 2362a may extend from the first protecting portion 2361. At least a portion of the second protecting portion 2362a may face at least a portion of the second display area A2.

Referring to FIG. 9B, the third protecting member 236 may include a second protecting portion 2362b covering at least a portion of the upper surface (e.g., the surface facing the +Z direction of FIGS. 7A, 7B, 8 and 9A to 9C) of the third display area A3. The second protecting portion 2362b may extend from the first protecting portion 2361. The third protecting member 236 may further include a curved surface 2363 formed on the second protecting portion 2362b. The curved surface 2363 may have a shape corresponding to the curved surface formed by the first folding area A4.

Referring to FIG. 9C, the third protecting member 236 may include a second protecting portion 2362c covering at least a portion of the upper surface (e.g., the surface facing the +Z direction of FIGS. 7A, 7B, 8 and 9A to 9C) of the third display area A3. The second protecting portion 2362c may extend from the first protecting portion 2361. The third protecting member 236 may further include a curved surface 2363a formed on the second protecting portion 2362c. The curved surface 2363a may have a shape corresponding to the curved surface formed by the first folding area A4. The third protecting member 236 may further include a third protecting portion 2364 extending from the second protecting portion 2362c. The third protecting portion 2364 may cover at least a portion of an upper end (e.g., an end facing the +Z direction of FIG. 9C) of the 3-2th side surface 232.

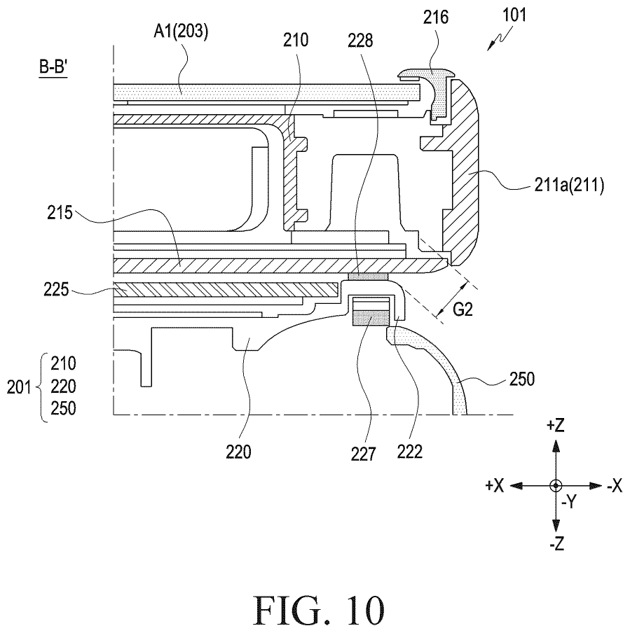

FIG. 10 is a cross-sectional view taken along line B-B′ of FIG. 3E according to an embodiment of the disclosure.

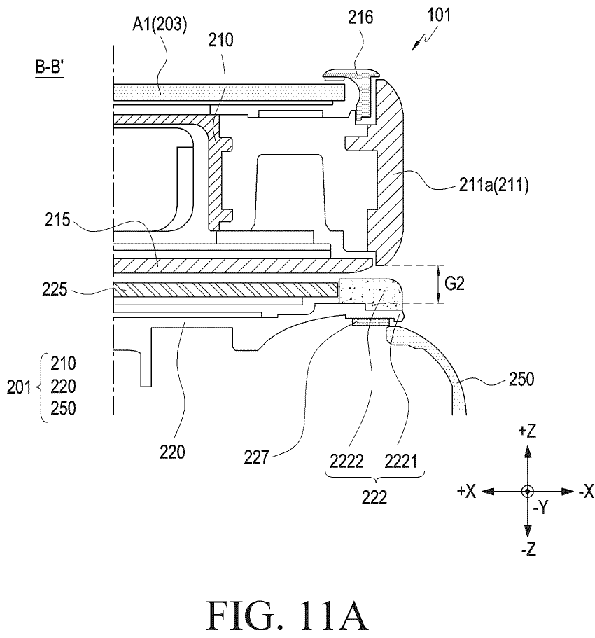

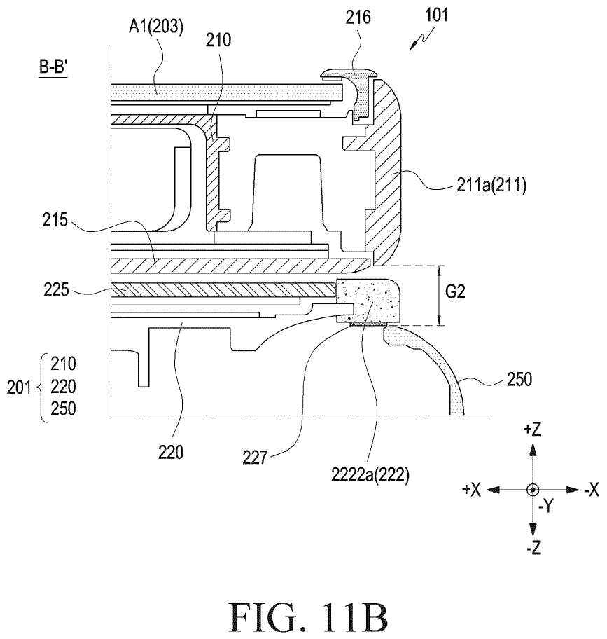

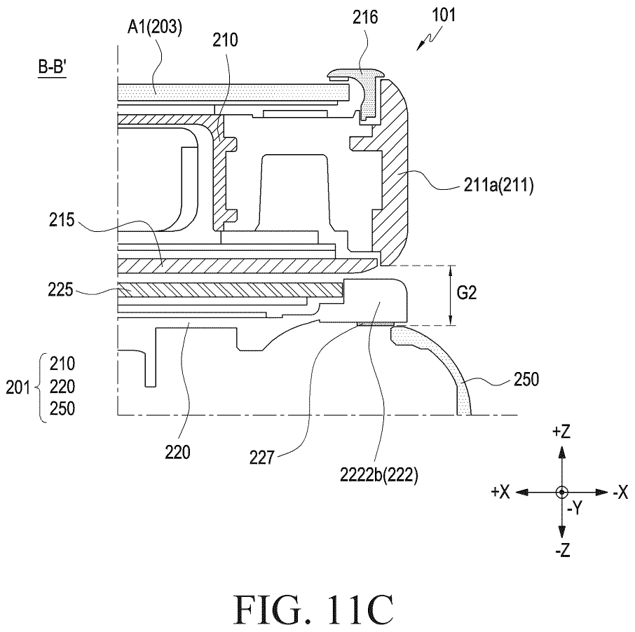

FIG. 11A is a cross-sectional view taken along line B-B′ of FIG. 3E according to an embodiment of the disclosure.

FIG. 11B is a cross-sectional view taken along line B-B′ of FIG. 3E according to an embodiment of the disclosure.

FIG. 11C is a cross-sectional view taken along line B-B′ of FIG. 3E according to an embodiment of the disclosure.

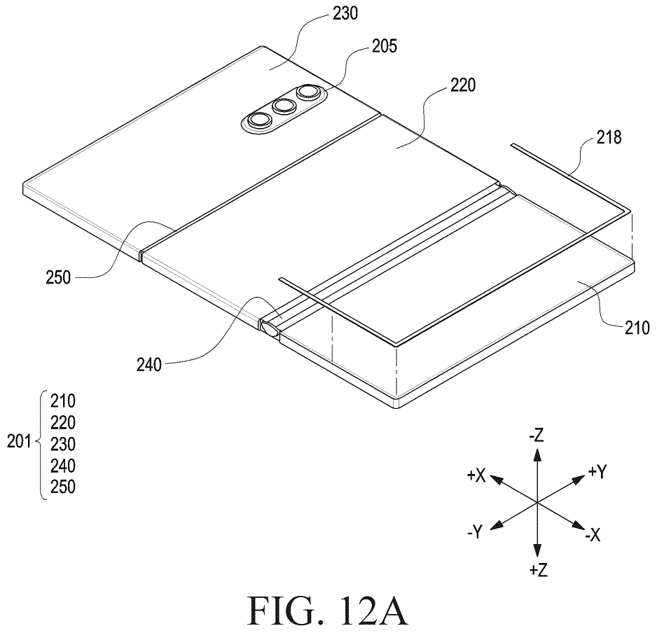

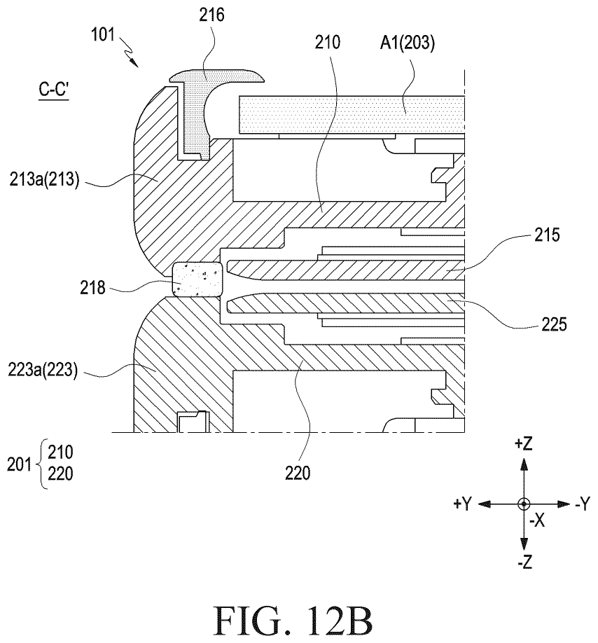

The embodiments of FIGS. 10 and 11A to 11C may be combined with the embodiments of FIGS. 1, 2A, 2B, 3A to 3G, 4, 5, 6A, 6B, 7A, 7B, 8, and 9A to 9C, or the embodiments of FIGS. 12A, 12B, 13, and 14.

The embodiments of FIGS. 10 and 11A to 11C illustrate a fully folded state of the electronic device 101 (e.g., FIGS. 3A to 3G), or a fully folded state of the first housing 210 and the second housing 220 (e.g., FIGS. 3A to 3G).

Referring to FIGS. 10 and 11A to 11C, an electronic device 101 (e.g., the electronic device 101 of FIG. 1, or the electronic device 101 of FIGS. 2A, 2B, 3A to 3G, 4, 5, 6A, 6B, 7A, 7B, 8, and 9A to 9C) may include a foldable housing 201, a flexible display 203, a first display area A1, a first housing 210, a 1-1th side surface 211, a 1-1th conductive portion 211a, a first rear cover 215, a first protecting member 216, a second housing 220, a 2-2th side surface 222, a second rear cover 225, or a second hinge structure 250.

The configuration of the foldable housing 201, the flexible display 203, the first display area A1, the first housing 210, the 1-1th side surface 211, the 1-1th conductive portion 211a, the first rear cover 215, the first protecting member 216, the second housing 220, the 2-2th side surface 222, the second rear cover 225, or the second hinge structure 250 of FIGS. 10 and 11A to 11C may be identical in whole or part to the configuration of the foldable housing 201, the flexible display 203, the first display area A1, the first housing 210, the 1-1th side surface 211, the 1-1th conductive portion 211a, the first rear cover 215, the first protecting member 216, the second housing 220, the 2-2th side surface 222, the second rear cover 225, or the second hinge structure 250 of FIGS. 2A, 2B, and 3A to 3G.

According to an embodiment, when the state of the electronic device 101 is the fully folded state, or when the state of the first housing 210 and the second housing 220 is the fully folded state, the first rear cover 215 may face the second rear cover 225, and the second hinge structure 250 may be at least partially exposed to the outside of the electronic device 101.

According to an embodiment, among the 1-1th side surface 211 of the first housing 210, the 1-1th conductive portion 211a (e.g., the 1-1th conductive portion 211a of FIGS. 3A to 3G, or the 1-1th conductive portion 211a of FIG. 6A) may be provided as a first antenna radiator 211a (e.g., the first antenna radiator 211a of FIG. 6A).

According to an embodiment, the first antenna radiator 211a may be electrically connected to the communication module (e.g., the communication module 190 of FIG. 1) and may operate as an antenna.

According to an embodiment, when the state of the electronic device 101 is the fully folded state, or when the state of the first housing 210 and the second housing 220 is the fully folded state, the first antenna radiator 211a may be spaced apart from the 2-2th side surface 222.

For example, a second gap G2 may be formed between the first antenna radiator 211a and the 2-2th side surface 222. The second gap G2 may be a minimum distance defined between the first antenna radiator 211a and the 2-2th side surface 222. The minimum distance may be defined and/or referred to as a second distance. The second gap G2 may be a separation distance between portions of the first antenna radiator 211a and the 2-2th side surface 222 that are disposed closest to each other. For example, the second gap G2 may be a separation distance between the 1-1th side surface 211 and the 2-2th side surface 222. For example, a partial area of the first antenna radiator 211a may be spaced apart from a partial area of the 2-2th side surface 222 by at least the second gap G2 or more. The second gap G2 may be about 0.9 mm to about 1.1 mm. For example, the second gap G2 may be about 1.0 mm or more. The second gap G2 is not limited thereto, and may have various values according to design changes of the electronic device 101, or the foldable housing 201.

According to an embodiment, as a sufficient second gap G2 is secured between the first antenna radiator 211a and the 2-2th side surface 222, the electronic device 101 may reduce or limit a phenomenon in which radio waves transmitted and received from the first antenna radiator 211a are lost by the 2-2th side surface 222 including a metallic material.

According to an embodiment, the electronic device 101, or the second housing 220, may further include a waterproofing member 227. The waterproofing member 227 may be located between the 2-2th side surface 222 and the second hinge structure 250. The waterproofing member 227 may be configured to seal a gap between the second hinge structure 250 and the 2-2th side surface 222 when the state of the electronic device 101 is the fully folded state, or when the state of the first housing 210 and the second housing 220 is the fully folded state.

Referring to FIG. 10, the electronic device 101, or the second housing 220, may further include a first spacer 228. The first spacer 228 may be disposed on the 2-2th side surface 222. The first spacer 228 may be formed of a non-metallic material, or a rubber material. The first spacer 228 may limit or prevent the 2-2th side surface 222 and/or the second rear cover 225 from directly colliding with the first rear cover 215 when the state of the electronic device 101 is the fully folded state, or when the state of the first housing 210 and the second housing 220 is the fully folded state. As the first spacer 228 is formed of the non-metallic material, or the rubber material, the antenna performance of the first antenna radiator 211a provided by the 1-1th side surface 211 may not be degraded. For example, as antenna radiation signals are not induced into the first spacer 228, the performance of the first antenna radiator 211a may not be degraded by the first spacer 228.

Referring to FIG. 11A, the 2-2th side surface 222 may include a metallic area 2221 and a non-metallic area 2222. The second gap G2 may be a minimum distance defined between the metallic area 2221 of the 2-2th side surface 222 and the first antenna radiator 211a.

Referring to FIG. 11B, the 2-2th side surface 222 may include a non-metallic area 2222a. The second gap G2 may be a minimum distance defined between the second hinge structure 250 including a metallic material and the first antenna radiator 211a.

Referring to FIG. 11C, the 2-2th side surface 222 may include a non-metallic area 2222b. The second housing 220 may be generally formed of a non-metallic material. The second gap G2 may be a minimum distance defined between the second hinge structure 250 including a metallic material and the first antenna radiator 211a.

FIG. 12A is a perspective view illustrating an electronic device according to an embodiment of the disclosure.

FIG. 12B is a cross-sectional view taken along line C-C′ of FIG. 3F according to an embodiment of the disclosure.

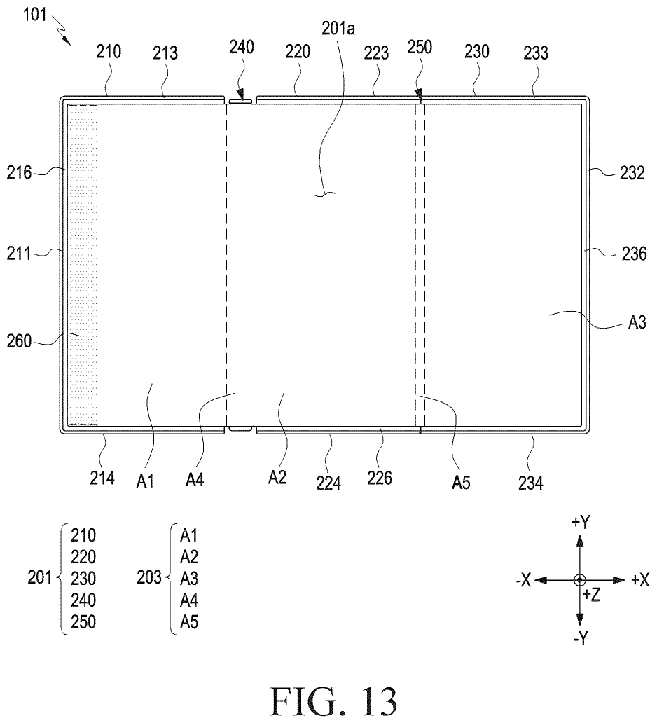

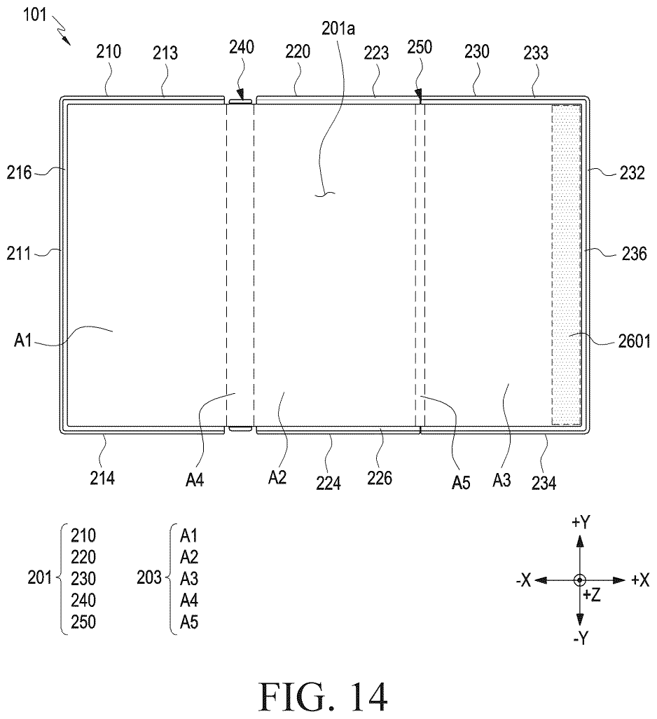

The embodiments of FIGS. 12A and 12B may be combined with the embodiments of FIGS. 1, 2A, 2B, 3A to 3G, 4, 5, 6A, 6B, 7A, 7B, 8, and 9A to 9C, 10, and 11A to 11C, or the embodiments of FIGS. 13 and 14.

The embodiment illustrated in FIG. 12B illustrates a fully folded state of the electronic device 101, or a fully folded state of the first housing 210 and the second housing 220.

Referring to FIGS. 12A and 12B, an electronic device 101 (e.g., the electronic device 101 of FIG. 1, or the electronic device 101 of FIGS. 2A, 2B, 3A to 3G, 4, 5, 6A, 6B, 7A, 7B, 8, and 9A to 11C) may include a foldable housing 201, a flexible display 203, a first display area A1, a first housing 210, a 1-3th side surface 213, a 1-4th conductive portion 213a, a first rear cover 215, a first protecting member 216, a second housing 220, a 2-3th side surface 223, a 2-1th conductive portion 223a, a second rear cover 225, a third housing 230, a first hinge structure 240, a second hinge structure 250, or a rear camera 205.

The configuration of the foldable housing 201, the flexible display 203, the first display area A1, the first housing 210, the 1-3th side surface 213, the 1-4th conductive portion 213a, the first rear cover 215, the first protecting member 216, the second housing 220, the 2-3th side surface 223, the 2-1th conductive portion 223a, the second rear cover 225, the third housing 230, the first hinge structure 240, the second hinge structure 250, or the rear camera 205 of FIGS. 12A and 12B may be identical in whole or part to the configuration of the foldable housing 201, the flexible display 203, the first display area A1, the first housing 210, the 1-3th side surface 213, the 1-4th conductive portion 213a, the first rear cover 215, the first protecting member 216, the second housing 220, the 2-3th side surface 223, the 2-1th conductive portion 223a, the second rear cover 225, the third housing 230, the first hinge structure 240, the second hinge structure 250, or the rear camera 205 of FIGS. 3A to 3G.

According to an embodiment, when the state of the electronic device 101 is the fully folded state, or when the state of the first housing 210 and the second housing 220 is the fully folded state, the first rear cover 215 may face the second rear cover 225.

According to an embodiment, the electronic device 101, or the first housing 210, may further include a second spacer 218. The second spacer 218 may be formed of a non-metallic material, or a rubber material. The second spacer 218 may be disposed on the first housing 210. For example, the second spacer 218 may be disposed on side surfaces (e.g., the 1-1th side surface 211, the 1-3th side surface 213, and/or the 1-4th side surface 214 of FIGS. 2A, 2B, and 3A to 3G) of the first housing 210. The second spacer 218 may limit, or reduce, the side surfaces of the first housing 210 and the side surfaces (e.g., the 2-2th side surface 222, the 2-3th side surface 223, and/or the 2-4th side surface 224 of FIGS. 2A, 2B, and 3A to 3G) of the second housing 220 from directly colliding with each other. As the second spacer 218 is formed of the non-metallic material, or the rubber material, the second spacer 218 may prevent the side surfaces of the first housing 210 and the side surfaces of the second housing 220 from being electrically connected. Accordingly, interference to an antenna (or an antenna structure) provided by the side surfaces of the first housing 210 by a metallic portion (or a conductive portion) of the side surfaces of the second housing 220 may be limited or blocked by the spacer 218, and the performance of the antenna (or the antenna structure) provided by the side surfaces of the first housing 210 may not be degraded. Interference to an antenna (or an antenna structure) provided by the side surfaces of the second housing 220 by a metallic portion (or a conductive portion) of the side surfaces of the first housing 210 may be limited or blocked by the spacer 218, and the performance of the antenna (or the antenna structure) provided by the side surfaces of the second housing 220 may not be degraded. According to the illustrated embodiment, the second spacer 218 may be located between the 1-3th side surface 213 and the 2-3th side surface 223 and may limit, or reduce, the 1-3th side surface 213 and the 2-3th side surface 223 from directly colliding with each other.

FIG. 13 is a front view illustrating an unfolded state of an electronic device according to an embodiment of the disclosure.

FIG. 14 is a front view illustrating the unfolded state of an electronic device according to an embodiment of the disclosure.

The embodiments of FIGS. 13 and 14 may be combined with the embodiments of FIGS. 1, 2A, 2B, 3A to 3G, 4, 5, 6A, 6B, 7A, 7B, 8, and 9A to 9C, 10, 11A to 11C, 12A, and 12B.

Referring to FIGS. 13 to 14, an electronic device 101 (e.g., the electronic device 101 of FIG. 1, or the electronic device 101 of FIGS. 2A, 2B, 3A to 3G, 4, 5, 6A, 6B, 7A, 7B, 8, and 9A to 9C, 10, 11A to 11C, 12A, and 12B) may include a foldable housing 201, a first housing 210, a 1-1th side surface 211, a 1-2th side surface 212, a 1-3th side surface 213, a second housing 220, a 2-3th side surface 223, a 2-4th side surface 224, a third housing 230, a 3-2th side surface 232, a 3-3th side surface 233, a 3-4th side surface 234, a first hinge structure 240, a second hinge structure 250, a flexible display 203, a first display area A1, a second display area A2, a third display area A3, a first folding area A4, or a second folding area A5.

The configuration of the foldable housing 201, the first housing 210, the 1-1th side surface 211, the 1-2th side surface 212, the 1-3th side surface 213, the second housing 220, the 2-3th side surface 223, the 2-4th side surface 224, the third housing 230, the 3-2th side surface 232, the 3-3th side surface 233, the 3-4th side surface 234, the first hinge structure 240, the second hinge structure 250, the flexible display 203, the first display area A1, the second display area A2, the third display area A3, the first folding area A4, or the second folding area A5 of FIGS. 13 and 14 may be identical in whole or part to the configuration of the foldable housing 201, the first housing 210, the 1-1th side surface 211, the 1-2th side surface 212, the 1-3th side surface 213, the second housing 220, the 2-3th side surface 223, the 2-4th side surface 224, the third housing 230, the 3-2th side surface 232, the 3-3th side surface 233, the 3-4th side surface 234, the first hinge structure 240, the second hinge structure 250, the flexible display 203, the first display area A1, the second display area A2, the third display area A3, the first folding area A4, or the second folding area A5 of FIGS. 2A and 2B.

According to an embodiment, when the state of the electronic device 101 is the fully unfolded state, the first display area A1, the second display area A2, the third display area A3, the first folding area A4, and the second folding area A5 may substantially form a flat surface and may form at least a portion of a front surface 201a of the electronic device 101.

According to an embodiment, the electronic device 101 may further include a display driver integrated circuit (DDI) 260, 2601. The display driver integrated circuit 260, 2601 may be electrically connected to at least a portion of the flexible display 203. The display driver integrated circuit 260, 2601 may include a display driver chip capable of implementing various colors by adjusting a plurality of pixels included in the flexible display 203.

Referring to FIG. 13, the display driver integrated circuit 260 may be electrically connected to the first display area A1. The display driver integrated circuit 260 may be disposed adjacent to the 1-1th side surface 211. As the display driver integrated circuit 260 is disposed adjacent to the 1-1th side surface 211, the display driver integrated circuit 260 may be disposed at a position farthest from the 3-2th side surface 232 inside the electronic device 101. Accordingly, the antenna performance of the second antenna radiator 232a (e.g., the second antenna radiator 232a of FIG. 6B) provided by the 3-2th side surface 232 may be limited or decreased from being degraded by noise generated from the display driver integrated circuit 260.

Referring to FIG. 14, a display driver integrated circuit 2601 may be electrically connected to the third display area A3. The display driver integrated circuit 2601 may be disposed adjacent to the 3-2th side surface 232. As the display driver integrated circuit 2601 is disposed adjacent to the 3-2th side surface 232, the display driver integrated circuit 2601 may be disposed at a position farthest from the 1-1th side surface 211 inside the electronic device 101. Accordingly, the antenna performance of the first antenna radiator 211a (e.g., the first antenna radiator 211a of FIG. 6A) provided by the 1-1th side surface 211 may be limited or decreased from being degraded by noise generated from the display driver integrated circuit 2601.

An electronic device may include a flexible display that is partially folded or unfolded. The electronic device including the flexible display may include a plurality of housings that are rotatably connected relative to each other. An antenna for transmitting/receiving a signal to and from an external electronic device may be disposed on a side portion of the plurality of housings.

When the housings of the electronic device are in a folded state relative to each other, an antenna disposed on one housing may experience antenna signal loss due to a metallic portion of an adjacently disposed housing or a portion of the flexible display.

According to an embodiment of the disclosure, an electronic device may be provided in which an antenna radiator is spaced apart from the flexible display or a conductive portion of the housing by a designated distance or more.

According to an embodiment of the disclosure, a flexible display providing an antenna structure with enhanced antenna performance and an electronic device including the same may be provided.

However, the problems to be solved in the disclosure are not limited to the above-mentioned problems, and may be variously extended without departing from the spirit and scope of the disclosure.

According to an embodiment of the disclosure, as the antenna radiator is spaced apart from the flexible display or a metallic portion by a designated distance or more, when the antenna radiator operates as an antenna, signal loss may be limited or decreased.

The effects obtainable in the disclosure are not limited to the above-mentioned effects, and other effects not mentioned is clearly understood by those skilled in the art to which the disclosure belongs from the description below.

According to an embodiment of the disclosure, an electronic device 101 may include a multi-foldable housing 201, a flexible display 203, at least one circuit board 206, or a communication module 190. The multi-foldable housing 201 may include a second housing 220, a first housing 210, an out-folding hinge 240, or an in-folding hinge 250. The first housing 210 may include a first side surface 211, or a first antenna radiator 211a. The first antenna radiator 211a may be disposed on the first side surface 211. The first housing 210 may be rotatably connected to one side surface 221 of the second housing 220. The third housing 230 may include a second side surface 232, or a second antenna radiator 232a. The second antenna radiator 232a may be disposed on the second side surface 232. The third housing 230 may be rotatably connected to another side surface 222 of the second housing 220. The out-folding hinge 240 may be disposed between the second housing 220 and the first housing 210. The in-folding hinge 250 may be disposed between the second housing 220 and the third housing 230. The flexible display 203 may be disposed on a front surface of each of the first housing 210, the second housing 220, or the third housing 230. The at least one circuit board 206 may be disposed inside the housing 201. The communication module 190 may be disposed on the at least one circuit board 206. The communication module 190 may be electrically connected to the first antenna radiator 211a, or the second antenna radiator 232a. When a state of the housing 201 is a folded state, at least a portion A4 of the flexible display 203, which is located on the out-folding hinge 240, may be visually exposed to an outside of the electronic device 101. When the state of the housing 201 is the folded state, the at least a portion A4 of the flexible display 203, which is located on the out-folding hinge 240, may be spaced apart from the second antenna radiator 232a.

According to an embodiment, when a state of the first housing 210 and the second housing 220 is a folded state, a first display area A1 of the flexible display 203, which is disposed on the first housing 210, may face an opposite direction to a second display area A2 of the flexible display 203, which is disposed on the second housing 220.

According to an embodiment, when a state of the second housing 220 and the third housing 230 is a folded state, the second display area A2 of the flexible display 203, which is disposed on the second housing 220, may face a third display area A3 of the flexible display 203, which is disposed on the third housing 230.

According to an embodiment, the first side surface 211 may include a first non-conductive portion 211d, or a second non-conductive portion 211e. The second non-conductive portion 211e may be spaced apart from the first non-conductive portion 211d. The first antenna radiator 211a may be defined by a conductive portion, which is disposed between the first non-conductive portion 211d and the second non-conductive portion 211e.

According to an embodiment, the second side surface 232 may include a third non-conductive portion 232d, or a fourth non-conductive portion 232e. The fourth non-conductive portion 232e may be spaced apart from the third non-conductive portion 232d. The second antenna radiator 232a may be defined by a conductive portion, which is disposed between the third non-conductive portion 232d and the fourth non-conductive portion 232e.

According to an embodiment, when the state of the housing 201 is the folded state, another portion A5 of the flexible display 203, which is located on the in-folding hinge 250, may be at least partially surrounded by the second housing 220, the third housing 230, and the in-folding hinge 250. When the state of the housing 201 is the folded state, the another portion A5 of the flexible display 203, which is located on the in-folding hinge 250, may face an inside of the electronic device 101.

According to an embodiment, when the state of the housing 201 is the folded state, the first antenna radiator 211a may be spaced apart from the another side surface 222 of the second housing 220.

According to an embodiment, the electronic device 101 may include a first spacer 228. The first spacer 228 may be disposed on the another side surface 222 of the second housing 220.

According to an embodiment, the electronic device 101 may include a second spacer 218. The second spacer 218 may be disposed on the first housing 210.

According to an embodiment, when the state of the housing 201 is the folded state, the first antenna radiator 211a may be spaced apart from the in-folding hinge 250.

According to an embodiment, the electronic device 101 may include a display driver integrated circuit 260, 2601. The display driver integrated circuit 260, 2601 may be electrically connected to the flexible display 203.

According to an embodiment, the display driver integrated circuit 260, 2601 may be disposed adjacent to one of the first side surface 211 or the second side surface 232.

According to an embodiment, the another side surface 222 of the second housing 220 may include a non-metallic area 2222, 2222a, 2222b.

According to an embodiment, the flexible display 203 may include the first display area A1, the second display area A2, the third display area A3, a first folding area A4, or a second folding area A5. The first display area A1 may be disposed on the first housing 210. The second display area A2 may be disposed on the second housing 220. The third display area A3 may be disposed on the third housing 230. The first folding area A4 may connect the first display area A1 and the second display area A2. The first folding area A4 may be disposed on the out-folding hinge 240. The first folding area A4 may be configured to be at least partially folded or unfolded. The second folding area A5 may connect the second display area A2 and the third display area A3. The second folding area A5 may be disposed on the in-folding hinge 250. The second folding area A5 may be configured to be at least partially folded or unfolded.

According to an embodiment, the electronic device 101 may include a protecting member 236. The protecting member 236 may be disposed on the second side surface 232 to cover at least a portion of an edge of the third display area A3. The protecting member 236 may include a non-metallic material.

According to an embodiment, an electronic device 101 may include a first housing 210, a second housing 220, a third housing 230, a first hinge structure 240, a second hinge structure 250, or a flexible display 203. The first housing 210 may include a first side surface 211, a second side surface 212, or a first conductive portion 211a. The second side surface 212 may face opposite to the first side surface 211. The first conductive portion 211a may be disposed on the first side surface 211. The second housing 220 may include a third side surface 221, or a fourth side surface 222. The third side surface 221 may be connected to the second side surface 212. The fourth side surface 222 may face opposite to the third side surface 221. The third housing 230 may include a fifth side surface 231, a sixth side surface 232, or a second conductive portion 232a. The fifth side surface 231 may be connected to the fourth side surface 222. The sixth side surface 232 may face opposite to the fifth side surface 231. The second conductive portion 232a may be disposed on the sixth side surface 232. The first hinge structure 240 may be connected to the second side surface 212 and the third side surface 221. The second hinge structure 250 may be connected to the fourth side surface 222 and the fifth side surface 231. The flexible display 203 may include a first display area A1, a second display area A2, a third display area A3, a first folding area A4, or a second folding area A5. The first display area A1 may be disposed on the first housing 210. The second display area A2 may be disposed on the second housing 220. The third display area A3 may be disposed on the third housing 230. The first folding area A4 may connect the first display area A1 and the second display area A2. The first folding area A4 may be disposed on the first hinge structure 240. The first folding area A4 may be configured to be at least partially folded or unfolded. The second folding area A5 may connect the second display area A2 and the third display area A3. The second folding area A5 may be disposed on the second hinge structure 250. The second folding area A5 may be configured to be at least partially folded or unfolded. When a state of the first housing 210 and the second housing 220 is a folded state, at least a portion of the first folding area A4 may be exposed to an outside of the electronic device 101. When the state of the first housing 210 and the second housing 220 is the folded state, the at least a portion of the first folding area A4 may be spaced apart from the second conductive portion 232a.

According to an embodiment, when a state of the first housing 210 and the second housing 220 is a folded state, the first conductive portion 211a may be spaced apart from the fourth side surface 222, or the second hinge structure 250.

According to an embodiment, the electronic device 101 may include a display driver integrated circuit 260, 2601. The display driver integrated circuit 260, 2601 may be electrically connected to the flexible display 203.

According to an embodiment, the display driver integrated circuit 260, 2601 may be disposed adjacent to one of the first side surface 211 or the sixth side surface 232.

According to an embodiment, the electronic device 101 may include a spacer 218. The spacer 218 may be disposed on the first side surface 211.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a multi-foldable housing including:
a second housing,
a first housing having a first side, the first housing including a first antenna radiator disposed on the first side and rotatably coupled to one side of the second housing,
a third housing having a second side, the third housing including a second antenna radiator disposed on the second side and rotatably coupled to the other side of the second housing,
an out-folding hinge disposed between the second housing and the first housing, and
an in-folding hinge disposed between the second housing and the third housing,
a flexible display disposed on a front surface of each of the first housing, the second housing, and the third housing;
at least one circuit board disposed inside the multi-foldable housing; and
a communication module mounted on the at least one circuit board and electrically connected to the first antenna radiator and the second antenna radiator,
wherein, when the multi-foldable housing is in a folded state, at least a portion of the flexible display that is located on the out-folding hinge is visually exposed to an outside of the electronic device and is spaced apart from the second antenna radiator.

2. The electronic device of claim 1, wherein when a state of the first housing and the second housing is a folded state, a first display area of the flexible display, which is disposed on the first housing, faces an opposite direction to a second display area of the flexible display, which is disposed on the second housing.

3. The electronic device of claim 2, wherein when a state of the second housing and the third housing is a folded state, a second display area of the flexible display, which is disposed on the second housing, faces a third display area of the flexible display, which is disposed on the third housing.

4. The electronic device of claim 1,
wherein the first side includes a first non-conductive portion and a second non-conductive portion spaced apart from the first non-conductive portion, and
wherein the first antenna radiator is defined by a conductive portion, which is disposed between the first non-conductive portion and the second non-conductive portion.

5. The electronic device of claim 1,
wherein the second side includes a third non-conductive portion and a fourth non-conductive portion spaced apart from the third non-conductive portion, and
wherein the second antenna radiator is defined by a conductive portion, which is disposed between the third non-conductive portion and the fourth non-conductive portion.

6. The electronic device of claim 1,
wherein when the state of the multi-foldable housing is the folded state, another portion, which is located on the in-folding hinge, of the flexible display is at least partially surrounded by the second housing, the third housing and the in-folding hinge, and
wherein when the state of the multi-foldable housing is the folded state, the another portion of the flexible display faces an inside of the electronic device.

7. The electronic device of claim 1, wherein when the state of the multi-foldable housing is the folded state, the first antenna radiator is spaced apart from the other side s of the second housing.

8. The electronic device of claim 1, further comprising a first spacer disposed on the other side of the second housing.

9. The electronic device of claim 1, further comprising a second spacer disposed on the first housing.

10. The electronic device of claim 1, wherein when the state of the multi-foldable housing is the folded state, the first antenna radiator is spaced apart from the in-folding hinge.

11. The electronic device of claim 1, further comprising a display driver integrated circuit electrically connected to the flexible display.

12. The electronic device of claim 11, wherein the display driver integrated circuit is disposed adjacent to one of the first side or the second side.

13. The electronic device of claim 1, wherein the other side of the second housing includes a non-metallic area.

14. The electronic device of claim 3, wherein the flexible display includes:
the first display area disposed on the first housing;
the second display area disposed on the second housing;
the third display area disposed on the third housing;
a first folding area connecting the first display area and the second display area, disposed on the out-folding hinge and at least partially configured to be folded or unfolded; and
a second folding area connecting the second display area and the third display area, disposed on the in-folding hinge and at least partially configured to be folded or unfolded.

15. The electronic device of claim 3, further comprising a protecting member disposed on the second side to cover at least part of an edge of the third display area, and including a non-metallic material.

16. The electronic device of claim 2,
wherein the first side includes a first non-conductive portion and a second non-conductive portion spaced apart from the first non-conductive portion, and
wherein the first antenna radiator is defined by a conductive portion, which is disposed between the first non-conductive portion and the second non-conductive portion.

17. The electronic device of claim 3,
wherein the first side includes a first non-conductive portion and a second non-conductive portion spaced apart from the first non-conductive portion, and
wherein the first antenna radiator is defined by a conductive portion, which is disposed between the first non-conductive portion and the second non-conductive portion.

18. The electronic device of claim 2,
wherein the second side includes a third non-conductive portion and a fourth non-conductive portion spaced apart from the third non-conductive portion, and
wherein the second antenna radiator is defined by a conductive portion, which is disposed between the third non-conductive portion and the fourth non-conductive portion.
